(19) United States
(12) Patent Application Publication
(10) Pub. No.: US 2014/0195011 A1
(43) Pub. Date: Jul. 10, 2014

(54) INFORMATION-PROCESSING DEVICE, METHOD FOR CONTROLLING INFORMATION-PROCESSING DEVICE, CONTROL TARGET DEVICE, METHOD FOR CONTROLLING CONTROL TARGET DEVICE, SERVER, METHOD FOR CONTROLLING SERVER, PAIRING SYSTEM, CONTROL PROGRAM, AND STORAGE MEDIUM

(71) Applicant: SHARP KABUSHIKI KAISHA, Osaka-shi, Osaka (JP)

(72) Inventors: Makoto Sakuta, Osaka-shi (JP); Masahiro Chiba, Osaka-shi (JP); Yoshiharu Yoshimoto, Osaka-shi (JP); Masaki Hashiura, Osaka-shi (JP)

(73) Assignee: SHARP KABUSHIKI KAISHA, Osaka-shi, Osaka (JP)

(21) Appl. No.: 14/000,776

(22) PCT Filed: Apr. 25, 2013
(86) PCT No.: PCT/JP2013/062265

§ 371 Date: Aug. 21, 2013

(30) Foreign Application Priority Data
May 21, 2012 (JP) 2012-115911

(51) Int. Cl. G05B 15/02

(52) U.S. Cl. CPC G05B 15/02
USPC 700/11

(57) ABSTRACT

A smart phone includes (i) a list obtaining section for obtaining a connectable device list for specifying a self-propelled cleaner which (a) have authenticated, as an indoor pairing, a communication connection which allows the self-propelled cleaner to be controlled by using a communication via a LAN and therefore (b) can authenticate, as an outdoor pairing, a communication connection which allows the self-propelled cleaner to be controlled by using a communication via a WAN and (ii) a transmitting section which transmits a connection request to a control target device, which has been selected by a user from the connectable device list, so as to establish the outdoor pairing with the self-propelled cleaner.

### TECHNICAL FIELD

The present invention relates to an information-processing device and the like which can control a control target device by communicating with the control target device via a network.

### BACKGROUND ART

Conventionally, a technique has been widely studied in which a plurality of apparatuses are connected with each other via a wireless communication so that one of the apparatuses can remotely control the other of the apparatuses. For example, in recent years, diligent studies have been carried out on a technique of utilizing a wireless communication which conforms to a standard such as the IEEE802.15.4 standard and uses a radio wave of a 2.4 GHz band.

In a remote control that utilizes the wireless communication, it is necessary to establish a communication connection (i.e., pairing) between two apparatuses. Patent Literature 1 discloses a control apparatus that preferentially paired with a control target apparatus, which has not been paired with the control apparatus, among a plurality of control target apparatuses.

Here, according to the pairing, a user needs to carry out a series of pairing operations in which, for example, the apparatus to be controlled is set in a state for pairing in advance and then the apparatus which carries out controlling transmits a connection request to the apparatus to be controlled.

### CITATION LIST

### Patent Literature

[Patent Literature 1]

Japanese Patent Application Publication Tokukai No. 2010-81425 A (Publication date: Apr. 8, 2010)

### SUMMARY OF INVENTION

### Technical Problem

In order to enhance (i) a degree of freedom in designing a product and (ii) security strength of a wireless communication, it is sometimes necessary to carry out a plurality of pairings between two apparatuses. According to a conventional technique such as the control apparatus disclosed in Patent Literature 1, it is necessary to carry out separate pairing operations for the respective plurality of pairings. In view of usability, however, it is not preferable to necessitate the user to carry out pairing operations twice in order to activate similar functions, i.e., functions of controlling one apparatus by the other apparatus.

Meanwhile, in a case where a product is intentionally designed to necessitate only a single pairing, a degree of freedom in design decreases, and accordingly (i) a range of function and service which can be provided to the user is narrowed and (ii) the security of a wireless communication is weakened. In other words, there is a trade-off between (i) the degree of freedom in design and the security strength and (ii) the usability.

The present invention is accomplished in view of the problem, and its object is to provide an information-processing device and the like that can improve usability by reducing an operation load which is required for a user to establish a plurality of communication connections.

### Solution to Problem

In order to attain the object, an information-processing device of an aspect of the present invention is an information-processing device which communicates with a control target device via a network so as to control the control target device, the information-processing device including: obtaining means for obtaining specification information for specifying a control target device which (i) have authenticated, as a first communication connection, a communication connection which allows the control target device to be controlled by using a communication via a first network and therefore (ii) is ready to authenticate, as a second communication connection, a communication connection which allows the control target device to be controlled by using a communication via a second network that is different from the first network; and first transmitting means for transmitting a connection request to a control target device, which has been selected by a user based on specification information obtained by the obtaining means, so as to establish the second communication connection with the control target device.

In order to attain the object, a method of an aspect of the present invention for controlling an information-processing device is a method for controlling an information-processing device which communicates with a control target device via a network so as to control the control target device, the method including the steps of: obtaining specification information for specifying a control target device which (i) has authenticated, as a first communication connection, a communication connection which allows the control target device to be controlled by using a communication via a first network and therefore (ii) is ready to authenticate, as a second communication connection, a communication connection which allows the control target device to be controlled by using a communication via a second network that is different from the first network; and transmitting a connection request to a control target device, which has been selected by a user based on specification information obtained in the obtaining step, so as to establish the second communication connection with the control target device.

In order to attain the object, a control target device of an aspect of the present invention is a control target device which communicates with an information-processing device via a network so as to be controlled by the information-processing device, the control target device including: second judging means for judging, when a response is requested from the information-processing device which communicates with the control target device via a first network, whether or not the information-processing device establishes a communication connection which (i) allows the control target device to be controlled by using a communication via the first network and (ii) has been authenticated as a first communication connection; second transmitting means for transmitting device information for identifying the control target device to the information-processing device in a case where the second judging means has determined that the information-processing device establishes the communication connection which has been authenticated; and third transmitting means for transmitting, to a server, authentication information which indicates that a second communication connection has been authenticated, the third transmitting means transmitting the authentication information in a case where a connection request for the second communication connection, which allows the control target device to be controlled by using a communication via a second network that is different from the first network, is received from the information-processing device as a response to the device information which has been transmitted from the second transmitting means.

In order to attain the object, a method of an aspect of the present invention for controlling a control target device is a method for controlling a control target device which communicates with an information-processing device via a network so as to be controlled by the information-processing device, the method including the steps of: judging, when a response is requested from the information-processing device which communicates with the control target device via a first network, whether or not the information-processing device establishes a communication connection which (i) allows the control target device to be controlled by using a communication via the first network and (ii) has been authenticated as a first communication connection; transmitting device information for identifying the control target device to the information-processing device in a case where the information-processing device has been determined in the judging step to establish the communication connection which has been authenticated; and transmitting, to a server, authentication information which indicates that a second communication connection has been authenticated, the authentication information being transmitted in a case where a connection request for the second communication connection, which allows the control target device to be controlled by using a communication via a second network that is different from the first network, is received from the information-processing device as a response to the device information which has been transmitted in the step of transmitting device information.

In order to attain the object, a server of an aspect of the present invention includes storing means for causing a storage section to store connection information, which indicates that a second communication connection has been established between an information-processing device and a control target device, in a case where the server has received, from the control target device, authentication information which indicates that the second communication connection, which allows the control target device to be controlled by the information-processing device by using a communication via a second network, has been authenticated by the control target device.

In order to attain the object, a method of an aspect of the present invention for controlling a server includes the step of causing a storage section to store connection information, which indicates that a second communication connection has been established between an information-processing device and a control target device, in a case where authentication information has been received from the control target device, the authentication information indicating that the second communication connection, which allows the control target device to be controlled by the information-processing device by using a communication via a second network, has been authenticated by the control target device.

### Advantageous Effects of Invention

According to an aspect of the present invention, the information-processing device and the method for controlling the device of the present invention can (i) reduce an operation load on the user caused in establishing a plurality of communication connections and therefore (ii) improve usability.

According to an aspect of the present invention, the control target device and the method for controlling the device of the present invention can (i) reduce an operation load on the user caused in establishing a plurality of communication connections and therefore (ii) improve usability.

According to an aspect of the present invention, the server and the method for controlling the server of the present invention can specify a control target device that can be controlled by using a communication via the second network, and this allows the information-processing device to control the control target device.

### BRIEF DESCRIPTION OF DRAWINGS

FIG. 1 is a block diagram illustrating a configuration of main parts of a smart phone in accordance with Embodiment 1 of the present invention.

FIG. 2 is a block diagram illustrating a configuration of main parts of a self-propelled cleaner in accordance with Embodiment 1 of the present invention.

FIG. 3 is a block diagram illustrating a configuration of main parts of a server in accordance with Embodiment 1 of the present invention.

FIG. 4 is a view schematically illustrating a pairing system in accordance with Embodiment 1 of the present invention.

FIG. 5 is a transition diagram illustrating transition of a screen example displayed on the smart phone illustrated in FIG. 1, in a case where a user carries out an outdoor pairing.

FIG. 6 is a view schematically illustrating a network configuration in a case where a user controls the self-propelled cleaner illustrated in FIG. 2 with an outdoor pairing.

FIG. 7 is a view schematically illustrating a screen displayed on the smart phone illustrated in FIG. 1 in a case where a control command, which controls the self-propelled cleaner illustrated in FIG. 2 to capture an image of its surroundings by a camera and to transmit the captured image to the smart phone, is given from the smart phone to the self-propelled cleaner.

FIG. 8 is a schematic view. (a) of FIG. 8 illustrates an appearance example of the smart phone illustrated in FIG. 1, and (b) of FIG. 8 illustrates an example of how a user operates the smart phone.

FIG. 9 is a perspective view of the self-propelled cleaner illustrated in FIG. 2.

FIG. 10 is a flowchart illustrating an example of a first half of processes carried out in the pairing system illustrated in FIG. 4.

FIG. 11 is a flowchart illustrating an example of a second half of the processes carried out in the pairing system illustrated in FIG. 4.

FIG. 12 is a block diagram illustrating a configuration of main parts of a smart phone in accordance with Embodiment 2 of the present invention.

FIG. 13 is a block diagram illustrating a configuration of main parts of a self-propelled cleaner in accordance with Embodiment 2 of the present invention.

FIG. 14 is a flowchart illustrating an example of a first half of processes carried out in a pairing system in accordance with Embodiment 2 of the present invention.

### DESCRIPTION OF EMBODIMENTS

In the descriptions below, alphabetic letters are sometimes added to an identical reference numeral in order to clearly indicate that there exist a plurality of similar members. Such similar members are indicated as, for example, “communication section 20a”, “communication section 20b”, and “communication section 20c”. Meanwhile, the similar members are sometimes collectively referred to by omitting the alphabetic letters added to the reference numeral. For example, the communication section 20a, the communication section 20b, the communication section 20c, and an arbitrary combination of these are sometimes collectively referred to as “communication section 20”.

Moreover, identical reference numerals with different alphabetic letters are given to respective some members having different names, in order to clearly indicate that the some members relate to each other. Such members are indicated as, for example, “indoor pairing information 3a” and “outdoor pairing information 3b”.

### Embodiment 1

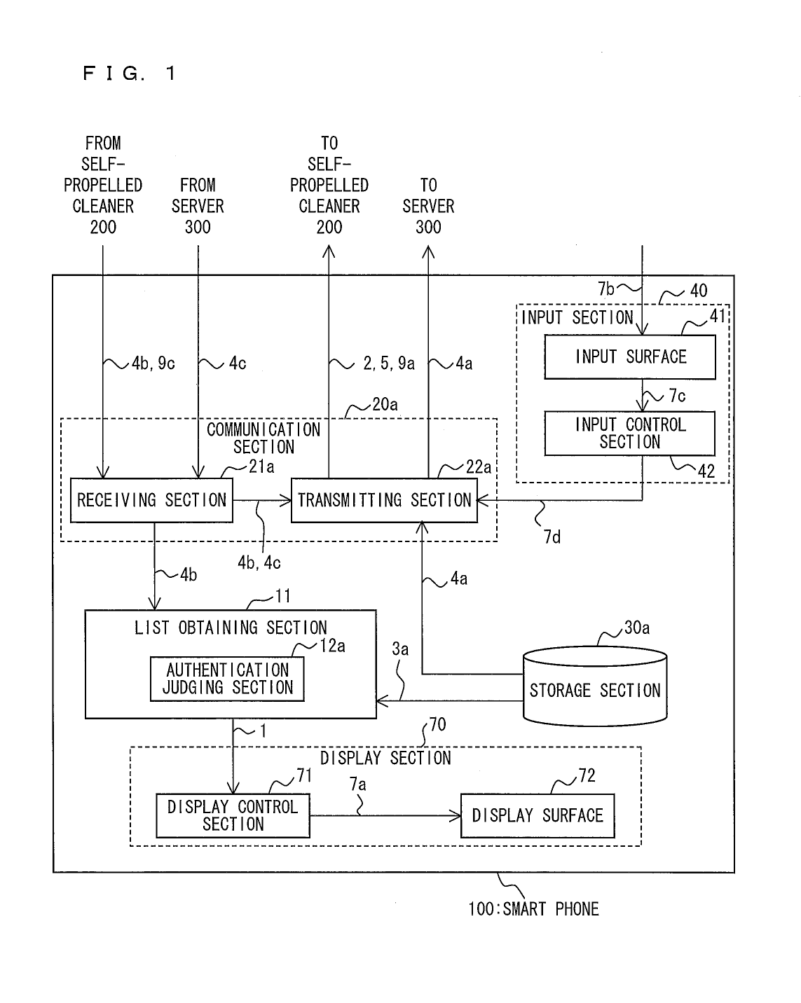

The following description will discuss Embodiment 1 of the present invention in detail, with reference to FIGS. 1 through 11.

[Overview of Pairing System 400]

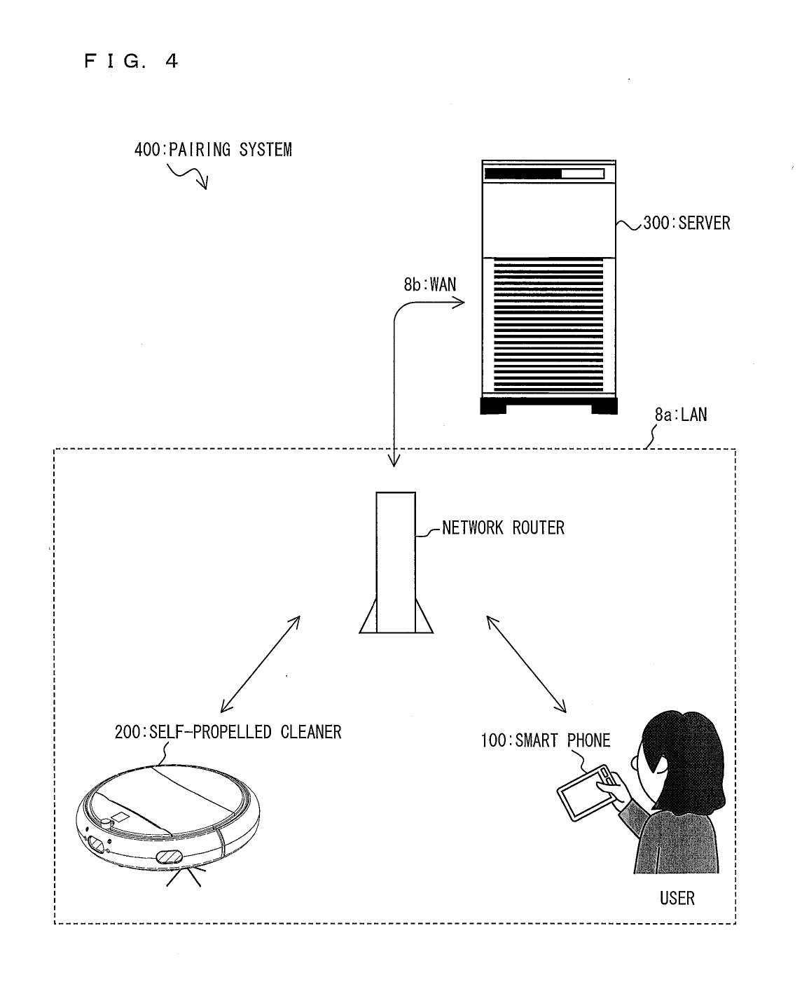

The following description will schematically discuss a pairing system 400 with reference to FIG. 4. FIG. 4 is a view schematically illustrating the pairing system 400. The pairing system 400 includes a smart phone 100, a self-propelled cleaner 200, and a server 300.

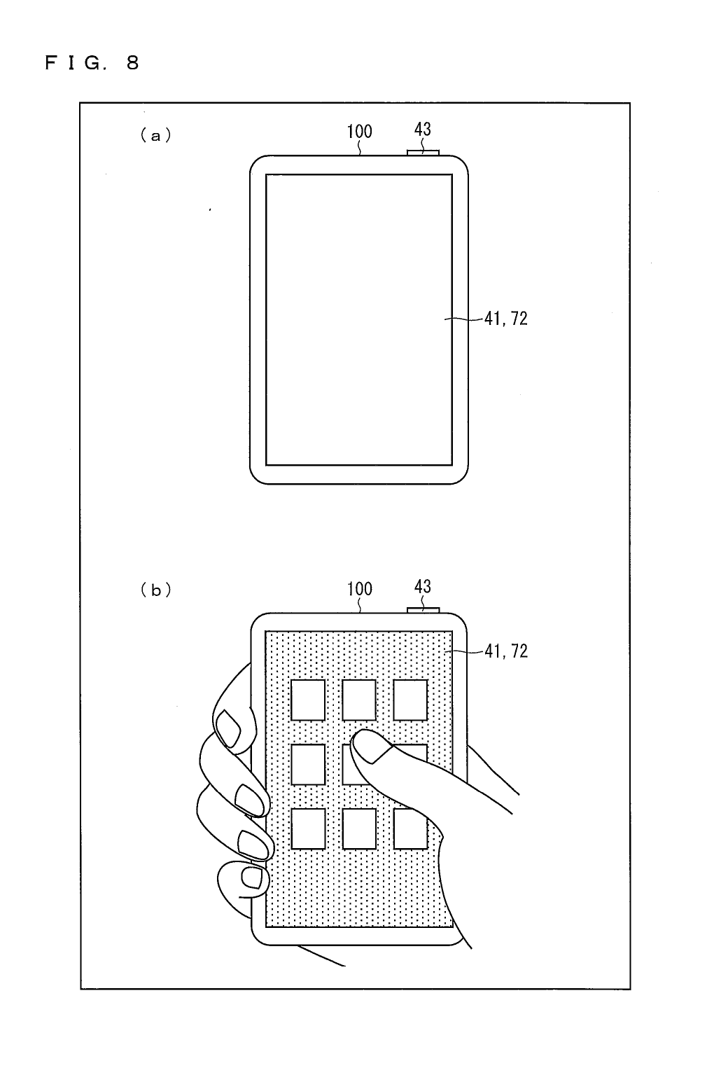

The smart phone (information-processing device) 100 is an information-processing device which communicates with the self-propelled cleaner 200 via a network so as to control the self-propelled cleaner 200. An appearance example and an operation example of the smart phone 100 will be described later in detail with reference to FIG. 8.

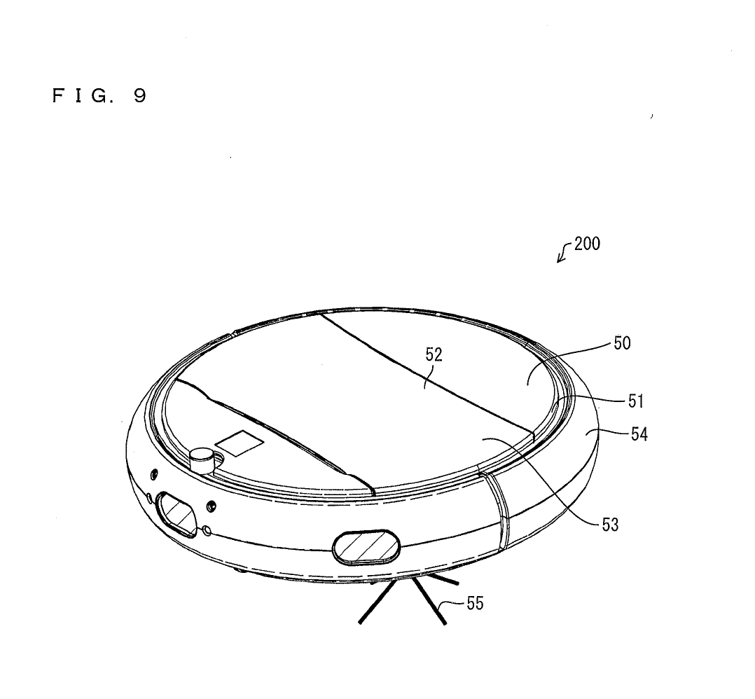

The self-propelled cleaner (control target device) 200 is a device for carrying out cleaning by sucking dust while self-propelling. The self-propelled cleaner 200 communicates with the smart phone 100 via the network so as to be controlled by the smart phone 100. An appearance example of the self-propelled cleaner 200 will be described later in detail with reference to FIG. 9.

The server 300 (i) receives a control command, which is used when the smart phone 100 controls the self-propelled cleaner 200, from the smart phone 100 and (ii) manages the control command. Moreover, the server 300 stores outdoor pairing information 3b (later described) which indicates that the smart phone 100 is paired with the self-propelled cleaner 200 by an outdoor pairing.

There are two types of communication connections (pairings) between the smart phone 100 and the self-propelled cleaner 200, that is, “indoor pairing” and “outdoor pairing”.

The indoor pairing (first communication connection) is a communication connection which allows the smart phone 100 to control the self-propelled cleaner 200 by using a communication via a local area network (LAN, first network) 8a. Note that information which indicates that an indoor pairing is established between the smart phone 100 and the self-propelled cleaner 200 is referred to as “indoor pairing information 3a”.

In a case where an indoor pairing has been established between the smart phone 100 and the self-propelled cleaner 200, a user can control the self-propelled cleaner 200, which can communicate with the smart phone 100 via an identical LAN 8a, by operating the smart phone 100. Specifically, the smart phone 100 can control the self-propelled cleaner 200 by transmitting a control command to the self-propelled cleaner 200 via a network router.

The outdoor pairing (second communication connection) is a communication connection which allows the smart phone 100 to control the self-propelled cleaner 200 by using a communication via a wide area network (WAN, second network) 8b. Note that information which indicates that an outdoor pairing is established between the smart phone 100 and the self-propelled cleaner 200 is referred to as “outdoor pairing information (connection information) 3b”.

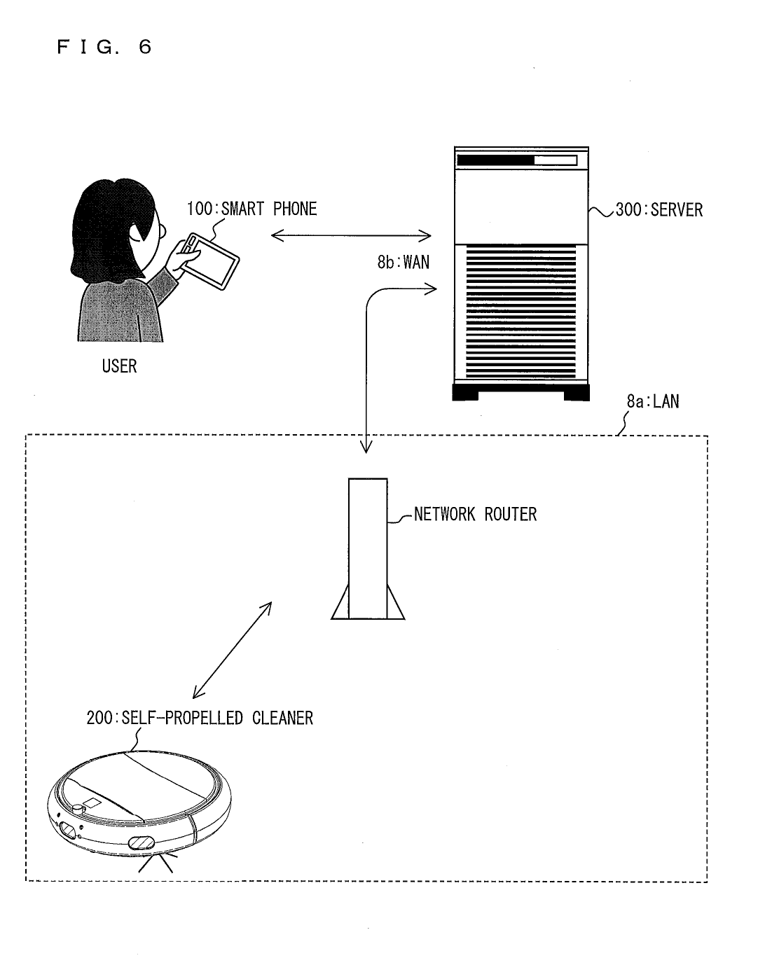

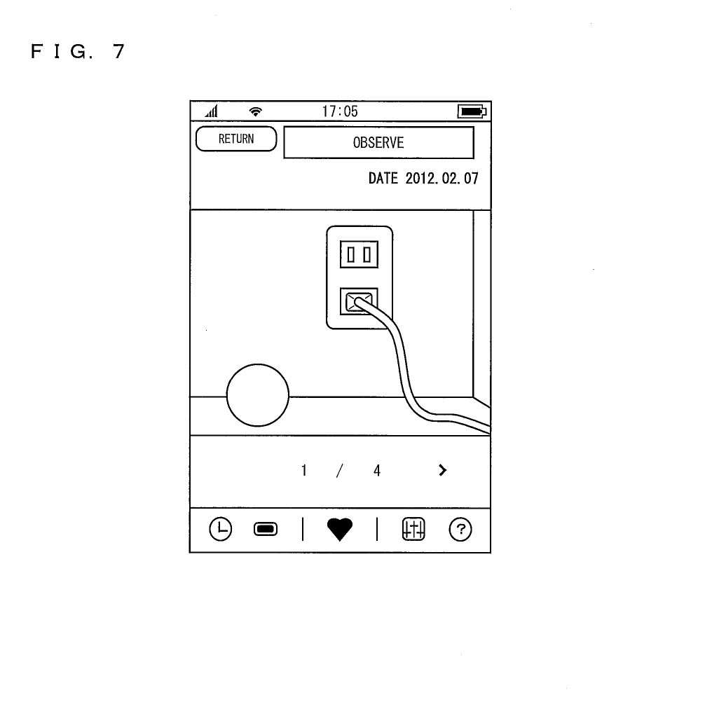

In a case where an outdoor pairing has been established between the smart phone 100 and the self-propelled cleaner 200, the user can control the self-propelled cleaner 200, which can communicate with the smart phone 100 via the WAN 8b, by operating the smart phone 100. In other words, the user can control also the self-propelled cleaner 200, which exists in a different network unit, by operating the smart phone 100. An example in which the smart phone 100 controls the self-propelled cleaner 200 by an outdoor pairing will be described later in detail with reference to FIGS. 6 and 7.

As such, the user can carry out the two types of pairings (i.e., the indoor pairing and the outdoor pairing) between the smart phone 100 and the self-propelled cleaner 200. Here, according to a conventional technique, separate operations are required for carrying out respective two types of pairings. In view of usability, however, it is not preferable to necessitate the user to carry out pairing operations twice in order to activate identical functions of remotely operating the self-propelled cleaner 200 with the smart phone 100.

According to the smart phone 100 of the present embodiment, in a case where the indoor pairing has been established between the smart phone 100 and the self-propelled cleaner 200, the user can establish the outdoor pairing merely by carrying out a simple operation (i.e., by selecting the self-propelled cleaner 200 which has already been paired with the smart phone 100 by the indoor pairing). That is, according to the smart phone 100, the user does not need to carry out identical operations twice for establishing the two types of pairings.

As such, the smart phone 100 can reduce an operation load required for the user to establish the plurality of pairings, and it is therefore possible to improve usability.

[Overview of Outdoor Pairing Procedures]

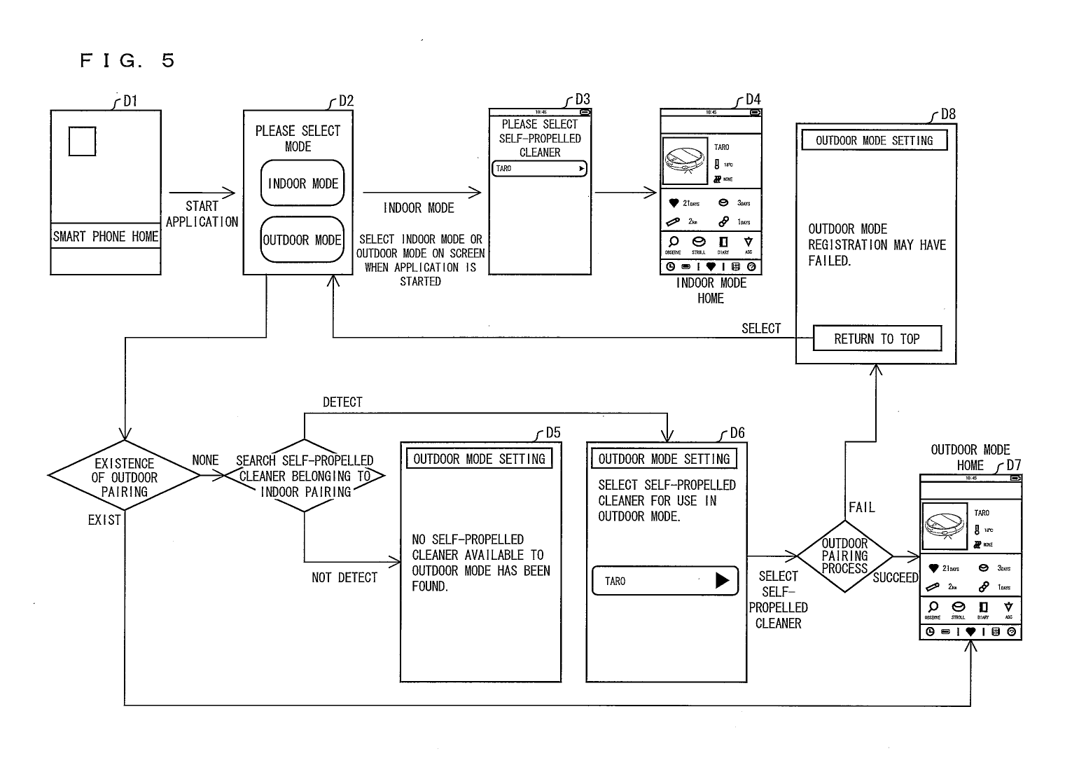

The following description will discuss how the user carries out an outdoor pairing, with reference to FIG. 5. FIG. 5 is a transition diagram illustrating transition of a screen example displayed on the smart phone 100, in a case where the user carries out an outdoor pairing.

When the user starts a predetermined application, which is used to pair the smart phone 100 with the self-propelled cleaner 200, from a home screen (display 1, abbreviated as “D1”) of the smart phone 100, the smart phone 100 displays a screen (D2) for prompting the user to select a mode.

In this case, an “indoor mode” displayed on the screen D2 is a mode in which the self-propelled cleaner 200 is controlled by the smart phone 100 with the indoor pairing, and an “outdoor mode” is a mode in which the self-propelled cleaner 200 is controlled by the smart phone 100 with the outdoor pairing.

In a case where the indoor mode is selected by the user, the smart phone 100 displays a list (D3) of all self-propelled cleaner(s) 200 which (i) can communicate with the smart phone 100 via the identical LAN 8a and accordingly (ii) can be paired with the smart phone 100 by the indoor pairing. When the user (i) selects a self-propelled cleaner 200 which is intended to be paired with the smart phone 100 by the indoor pairing and then (ii) carries out predetermined operations necessary for the indoor pairing, the indoor pairing is carried out between the smart phone 100 and the self-propelled cleaner 200. Subsequently, the smart phone 100 displays a home screen (D4) of the indoor mode. The user can transmit a control command to the self-propelled cleaner 200, which has been paired with the smart phone 100 by the indoor pairing, via an interface of the home screen.

Note that, in a case where the smart phone 100 and the selected self-propelled cleaner 200 have already been paired with each other by the indoor pairing, the processes and the predetermined operations by the user for carrying out the indoor pairing are omitted. The “predetermined operations necessary for the indoor pairing” are general pairing operations required also in a conventional technique, and therefore descriptions of such operations are omitted.

Meanwhile, in a case where the outdoor mode is selected by the user, the smart phone 100 judges whether or not there exists any self-propelled cleaner 200 which has already been paired with the smart phone 100 by the outdoor pairing. In a case where there exists a self-propelled cleaner 200 which has already been paired with the smart phone 100 by the outdoor pairing, the smart phone 100 displays a home screen (D7) of the outdoor mode. In a case where there exists no self-propelled cleaner 200 which has already been paired with the smart phone 100 by the outdoor pairing, the smart phone 100 searches a self-propelled cleaner 200, which has been paired with the smart phone 100 by the indoor pairing, so as to obtain a list of such self-propelled cleaner(s).

In a case where no self-propelled cleaner 200, which has been paired with the smart phone 100 by the indoor pairing, is detected, the smart phone 100 displays a screen (D5) which indicates that no self-propelled cleaner 200 exists which can be paired with the smart phone 100 by the outdoor pairing. This screen can display, for example, an explanation as follows: “In order to use a self-propelled cleaner in the outdoor mode, please carry out pairing with the self-propelled cleaner in the indoor mode, and then reconnect to a wireless LAN environment which is connected with the self-propelled cleaner.”

In a case where a self-propelled cleaner 200, which has been paired with the smart phone 100 by the indoor pairing, is detected, the smart phone 100 (i) displays a list of all self-propelled cleaner(s) 200 which can be paired with the smart phone 100 by the outdoor pairing and (ii) prompts the user to select any of the listed self-propelled cleaner(s) 200 (D6).

When (i) the user selects a self-propelled cleaner 200 which is intended to be paired with the smart phone 100 by the outdoor pairing and then (ii) processes for the outdoor pairing are appropriately carried out, the smart phone 100 displays a home screen (D7) of the outdoor mode. In a case where an error is detected during the processes, the smart phone 100 displays an error screen (D8). This error screen can display, for example, an explanation as follows: “Please check the connection status of the wireless LAN, and start over the registration. Please note that, in a case where the outdoor mode home is displayed, cancel the registration once from the setting screen of the outdoor mode, and then start over the registration.”

In the transition, for example, a screen (not illustrated) can be displayed, when the outdoor mode is selected, for prompting the user to agree to rules for using the outdoor mode.

[Control of Self-Propelled Cleaner 200 by Outdoor Pairing]

The following description will discuss a control example of the self-propelled cleaner 200 by the outdoor pairing, with reference to FIG. 6. FIG. 6 is a view schematically illustrating a network configuration in a case where the user controls the self-propelled cleaner 200 with the outdoor pairing. In FIG. 6 and FIG. 7 (later described), it is assumed that the outdoor pairing has already been established between the smart phone 100 and the self-propelled cleaner 200.

When the smart phone 100 transmits a control command to the server 300 via the WAN 8b, the server 300 manages the control command while associating the control command with outdoor pairing information 3b. The self-propelled cleaner 200 obtains a control command from the smart phone 100 by carrying out polling with respect to the server 300.

Here, the “polling” indicates a process in which the self-propelled cleaner 200 inquires of the server 300 whether or not the server 300 has received a control command with respect to the self-propelled cleaner 200 from the smart phone 100. When the self-propelled cleaner 200 detects, by the polling, a control command given from the smart phone 100, the self-propelled cleaner 200 obtains the control command from the server.

The self-propelled cleaner 200 executes a control instructed by the obtained control command, and then transmits an execution result to the server 300. The smart phone 100 can obtain the result by connecting to the server 300. Alternatively, the server 300 can push the execution result to the smart phone 100.

The following description will discuss, with reference to FIG. 7, a concrete example of a control command that can be given from the smart phone 100 to the self-propelled cleaner 200. FIG. 7 is a view schematically illustrating a screen displayed on the smart phone 100 in a case where a control command, which controls the self-propelled cleaner 200 to capture an image of its surroundings by a camera and to transmit the captured image to the smart phone 100, is given from the smart phone 100 to the self-propelled cleaner 200.

As illustrated in FIG. 7, in a case where the smart phone 100 transmits a control command (e.g., a command of “OBSERVE” as illustrated in FIG. 7) to the server 300 via the WAN 8b, it is possible to control the self-propelled cleaner 200, which is paired with the smart phone 100 by the outdoor pairing, (i) to capture an image of its surroundings by a camera and (ii) to transmit the captured image to the smart phone 100.

As such, in a case where the outdoor pairing is established between the smart phone 100 and the self-propelled cleaner 200, the user can control the self-propelled cleaner 200, which exists in a different network unit, by operating the smart phone 100.

[Appearance Example and Operation Example of Smart Phone 100]

The following description will discuss an example of an appearance of and an operation of the smart phone 100, with reference to FIG. 8. (a) of FIG. 8 schematically illustrates an appearance example of the smart phone 100, and (b) of FIG. 8 schematically illustrates an example of how the user operates the smart phone 100.

The smart phone 100 includes an input surface 41, a display surface 72, and a power switch 43 (see (a) of FIG. 8). Note that, in FIG. 1, the input surface 41 and the display surface 72 are separately depicted in order to clearly describe the functions of respective of the input surface 41 and the display surface 72.

However, in a case where the input surface 41 is configured by a touch panel and the display surface 72 is configured by a liquid crystal display, the input surface 41 and the display surface 72 can be integrally configured as illustrated in (a) of FIG. 8. According to the configuration, a location at which a finger of the user touches the input surface coincides with a location at which a graphic, etc. is displayed on the display surface 72 in response to the contact. This allows the user to experience a natural input feeling.

The user can give instruction information 7d (see FIG. 1), such as on an selection of an icon, to the smart phone 100 by touching the input surface 41 so as to specify a location on the input surface 41 (i.e., to give coordinates on the input surface 41) to the smart phone 100 as illustrated in (b) of FIG. 8.

As above described, the smart phone 100 is a mobile information terminal. A function similar to that of the smart phone 100 can be brought about by a mobile phone, a personal computer (in particular, a portable laptop computer), or a tablet terminal. That is, the terminal is not limited to the smart phone, provided that the terminal is an electronic apparatus that can input and output necessary information.

[Appearance Example of Self-Propelled Cleaner 200]

The following description will discuss an appearance of the self-propelled cleaner 200, with reference to FIG. 9. FIG. 9 is a perspective view of the self-propelled cleaner 200. As illustrated in FIG. 9, the self-propelled cleaner 200 is made up of a housing 53 which has an outer frame whose shape is round when viewed in a plan view.

On a top surface of the housing 53, an operation panel 50, a light emitting diode (LED) lamp 51, and a cover 52 are provided. The operation panel 50 is used to input instructions to the self-propelled cleaner 200. The cover 52 is opened or closed when a dust collection part is inserted or removed. According to the present embodiment, the housing 53 has the top surface and a bottom surface which have the round shape. Note, however, that the housing 53 is not limited to the round shape.

A suction port is provided in a front part of the bottom surface of the housing 53. The suction port is formed by an opening of a recessed part, which is provided in the bottom surface of the housing 53, so as to face a floor surface. In the recessed part, a rotation brush is provided which is rotated about a horizontal rotation axis. Moreover, side brushes 55, each of which is rotated about a vertical rotation axis, are provided on both sides of the recessed part.

A bumper 54 is provided around a periphery of the housing 53. The bumper 54 buffers impact and vibration to the self-propelled cleaner 200. In a case where the self-propelled cleaner 200 detects that the bumper 54 has made contact with an obstacle during running, the self-propelled cleaner 200 changes a traveling direction and then continues running.

[Configuration of Smart Phone 100]

The following description will discuss a configuration of the smart phone 100 in detail, with reference to FIG. 1. FIG. 1 is a block diagram illustrating a configuration of main parts of the smart phone 100.

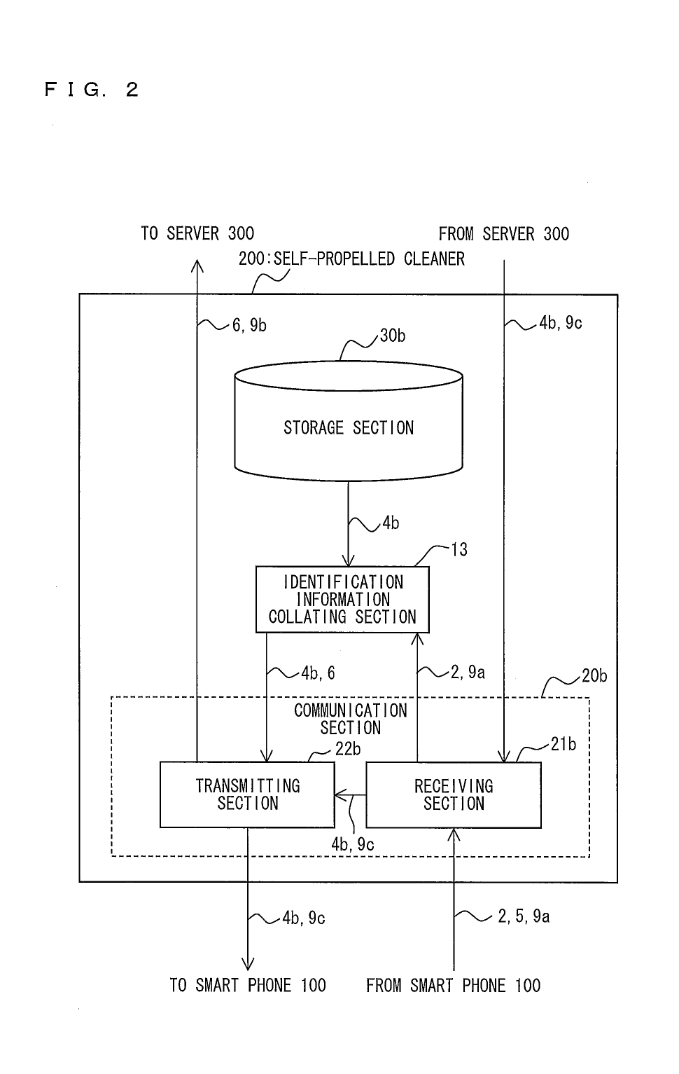

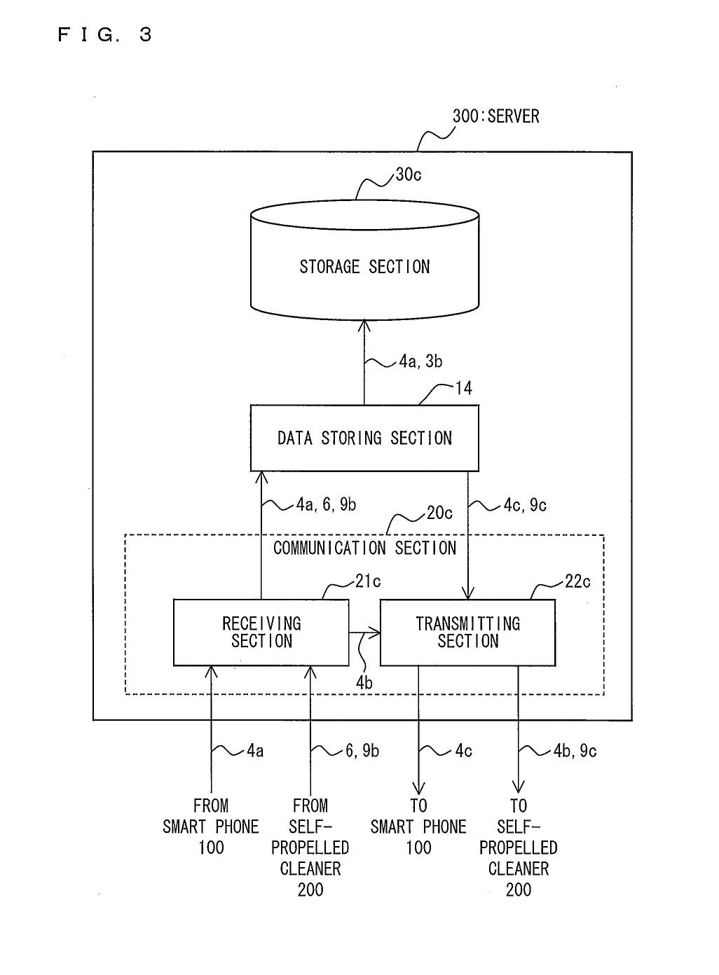

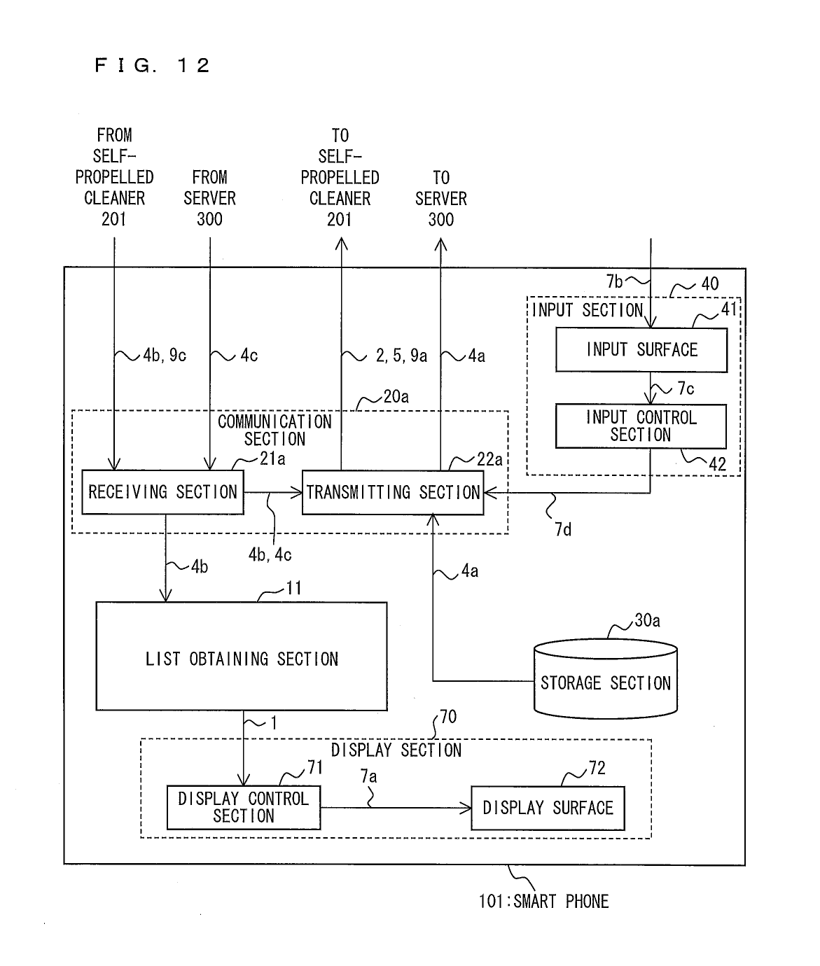

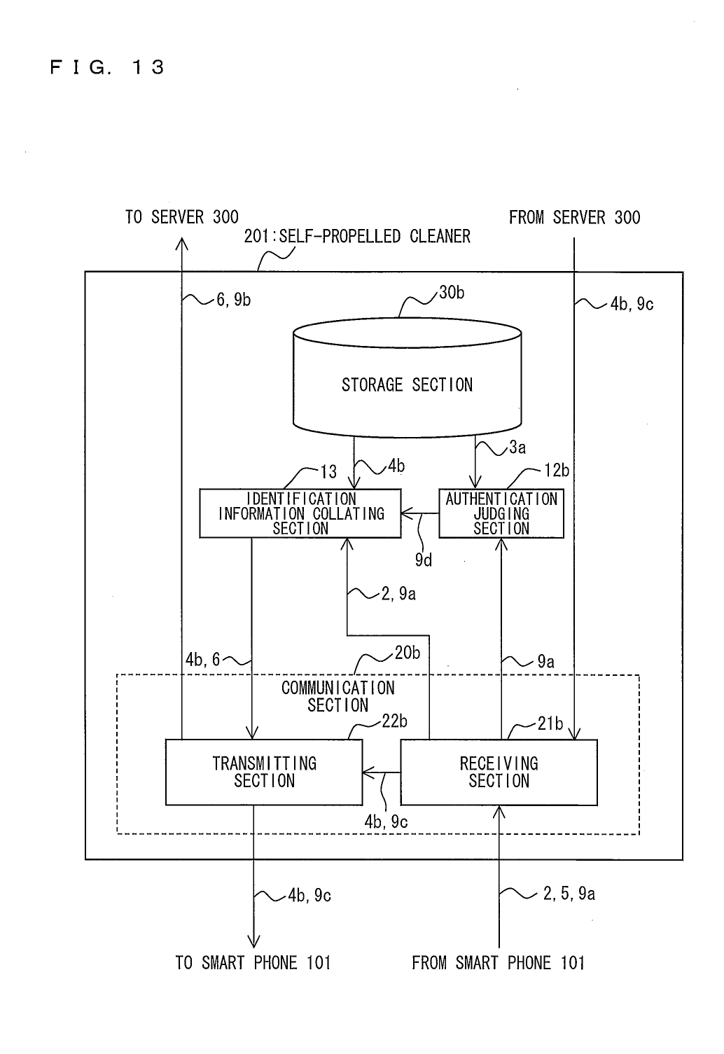

In view of simplification of description, parts which do not directly relate to the present embodiment are not described and are omitted from the block diagram. Note, however, that the smart phone 100 can include such omitted parts in accordance with actual implementation (the same applies to FIG. 2, FIG. 3, FIG. 12, and FIG. 13).

The following description will discuss functions of a communication section 20a (receiving section 21a, transmitting section 22a), a list obtaining section 11, an authentication judging section 12a, an input section 40 (input surface 41, input control section 42), a storage section 30a, and a display section 70 (display control section 71, display surface 72) in this order.

The communication section 20a communicates with the outside via a communication network in accordance with a predetermined communication system. The communication section 20a is not limited to a communication line, a communication system, a communication medium, or the like, provided that the communication section 20a has a substantial function for communicating with an external apparatus. The communication section 20a can be configured by an apparatus such as an Ethernet (Registered Trademark) adapter. For example, the communication section 20a can utilize a communication system or a communication medium such as an IEEE802.11 wireless communication or Bluetooth (Registered Trademark). The communication section 20a includes a receiving section 21a and a transmitting section 22a.

The receiving section (first receiving means) 21a receives communication information 4c from the server, and then sends the communication information 4c to the transmitting section 22a. In a case where the receiving section 21a has received instruction information 7d, which is indicative of an instruction on carrying out an outdoor pairing, from the input control section 42, the transmitting section 22a (i) reads out smart phone identification information 4a from the storage section 30a and then (ii) transmits the smart phone identification information 4a to the server 300. In response to the smart phone identification information 4a, the server 300 transmits communication information 4c, and the receiving section 21a then receives the communication information 4c. The smart phone 100 can thus obtain the communication information 4c (a detailed flow will be described later).

The communication information 4c is information based on which a communication can be uniquely identified. As later described, for example, in a case where the smart phone 100 transmits a connection request together with the communication information to the self-propelled cleaner 200, the server 300 can identify the smart phone 100 in a series of communications. Note that the communication information 4c is deleted if no access to the server 300 occurs for a predetermined time period.

The receiving section 21a (i) receives, from the self-propelled cleaner 200, self-propelled cleaner identification information (device information) 4b based on which the self-propelled cleaner 200 can be uniquely identified, and then (ii) sends the self-propelled cleaner identification information 4b to the list obtaining section 11 and to the transmitting section 22a. Further, the receiving section 21a receives polling start information 9c (later described) from the self-propelled cleaner 200.

The transmitting section (first transmitting means) 22a transmits a connection request 2 to a self-propelled cleaner 200, which has been selected by the user from a connectable device list 1 obtained by the list obtaining section 11, so that an outdoor pairing with the self-propelled cleaner 200 is carried out.

The connection request 2 contains (i) self-propelled cleaner identification information 4b and (ii) communication information 4c which has been sent from the receiving section 21a. Note that the transmitting section 22a transmits the connection request 2 to the self-propelled cleaner 200 via a connection identified by the communication information 4c which has been received by the receiving section 21a.

Specifically, when instruction information 7d, which indicates that a self-propelled cleaner 200 which is intended to be paired by an outdoor pairing has been selected from the connectable device list 1 (later described) displayed on the display surface 72, is sent from the input control section 42, the transmitting section 22a transmits the connection request 2 to the self-propelled cleaner 200 via a communication identified by the communication information 4c.

In a case where the outdoor pairing is authenticated by the self-propelled cleaner 200 which has been selected by the user from the connectable device list 1, a polling request (confirmation information) 5 for confirming that the self-propelled cleaner 200 is controllable by the outdoor pairing is transmitted to the self-propelled cleaner 200. Specifically, when the self-propelled cleaner identification information 4b is sent from the receiving section 21a, the transmitting section 22a transmits the polling request 5 to the self-propelled cleaner 200.

The polling request 5 (i) is a request from the smart phone 100 and (ii) requires the self-propelled cleaner 200 to carry out polling. The polling request 5 is transmitted from the smart phone 100 to the self-propelled cleaner 200 so as to confirm that the self-propelled cleaner 200 can be controlled by the smart phone 100. The polling request 5 contains the self-propelled cleaner identification information 4b of the self-propelled cleaner 200, which has been requested to pair with the smart phone 100 by the outdoor pairing.

The transmitting section 22a transmits, by a broadcast, a request 9a for self-propelled cleaner identification information 4b to all self-propelled cleaners 200 existing in the identical LAN 8a. This allows the smart phone 100 to confirm all the self-propelled cleaners 200 which can be communicated via the LAN 8a.

The list obtaining section (obtaining means) 11 obtains, as the connectable device list (specification information) 1, a list of self-propelled cleaners 200 each of which (i) has authenticated, as an indoor pairing, a communication connection which allows the self-propelled cleaner 200 to be controlled by using a communication via the local area network 8a and therefore (ii) is ready to authenticate, as an outdoor pairing, a communication connection which allows the self-propelled cleaner 200 to be controlled by using a communication via the wide area network 8b.

Specifically, the list obtaining section 11 adds to a list all self-propelled cleaners 200 which have been determined, by the authentication judging section 12a, to have authenticated indoor pairings, and obtains the list as the connectable device list 1. The list obtaining section 11 sends the connectable device list 1, which has been thus obtained, to the display control section 71.

The authentication judging section (first judging means) 12a judges whether or not a self-propelled cleaner 200, which can be communicated via the local area network 8a, has authenticated an indoor pairing.

The input section 40 accepts an operation (user operation 7b) from the user. The input section 40 includes the input surface 41 and the input control section 42.

The input surface 41 sends, to the input control section 42, two-dimensional coordinates information 7c that indicates two-dimensional coordinates of a location on the input surface 41 at which location the finger of the user has touched the input surface 41. According to the present embodiment, it is preferable that the input surface 41 is configured by a touch panel which can simultaneously detect a plurality of touches. Note, however, that a hardware type of the input surface 41 is not limited to the touch panel, provided that the input surface 41 is an input apparatus that can detect a touched location in response to an operation by the user.

The input control section 42 extracts instruction information 7d based on coordinates information 7c supplied from the input surface 41. In other words, the input control section 42 supplies, to the transmitting section 22a, contents (instruction information 7d) of instructions given from the user by the user operation.

The storage section 30a is a storage apparatus that can store indoor pairing information 3a and smart phone identification information 4a. The storage section 30a can be configured by, for example, a hard disk or a semiconductor memory. According to the present embodiment, the storage section 30a is depicted in FIG. 1 as an apparatus included in the smart phone 100. Note, however, that the storage section 30a can be an external storage device which is externally connected with the smart phone 100 so as to communicate with the smart phone 100.

The display section 70 displays, to the user, information (connectable device list 1) indicative of a result of the processes carried out by the list obtaining section 11 and the authentication judging section 12a. The display section 70 includes the display control section 71 and the display surface 72.

The display control section 71 supplies display data 7a to the display surface 72 so that the connectable device list 1 is displayed on the display surface 72. Examples of the display data 7a encompass a bit-mapped image, an image in other format, and other kind of data suitable for being displayed. Note that the display control section 71 can be configured by, for example, a general display adapter, provided that such a display adapter can convert a format of contents, which is to be displayed, into the display data 7a.

The display surface 72 is a device that can display display data 7a received from the display control section 71. In the present embodiment, the display surface 72 is mainly assumed to be a liquid crystal display (LCD). Note, however, that a hardware type of the display surface 72 is not limited to a particular one, provided that the display surface 72 is a device (in particular, a flat-panel display) having a displaying function. The display surface 72 can be configured by, for example, (i) a display element such as a plasma display panel (PDP) or an electroluminescence (EL) display and (ii) a driver circuit for driving the display element based on display data 7a received from the display control section 71.

As early described, in a case where the input surface 41 is configured by a touch panel and the display surface 72 is configured by a liquid crystal display, the input surface 41 and the display surface 72 can be integrally configured. In this case, the input surface 41 (i) is made from a transparent member, such as glass, which is formed in a quadrangular plate shape and (ii) is integrated with the display surface 72 so as to cover the display surface 72. According to the configuration, a location at which the finger of the user touches the input surface 41 coincides with a location at which a graphic, etc. is displayed on the display surface 72 in response to the contact. This allows the user to experience a natural input feeling.

[Configuration of Self-Propelled Cleaner 200]

The following description will discuss a configuration of the self-propelled cleaner 200 in detail, with reference to FIG. 2. FIG. 2 is a block diagram illustrating a configuration of main parts of the self-propelled cleaner 200. The following description will discuss functions of a communication section 20b (receiving section 21b, transmitting section 22b), an identification information collating section 13, and a storage section 30b in this order.

The communication section 20b has a function identical with that of the communication section 20a, and therefore a detailed description of the communication section 20b is omitted. The communication section 20b includes a receiving section 21b and a transmitting section 22b.

The receiving section 21b receives a request 9a distributed by a broadcast, a connection request 2, and a polling request 5 from the smart phone 100. In a case where the receiving section 21b has received the request 9a or the connection request 2, the receiving section 21b sends the request 9a or the connection request 2 to the identification information collating section 13. In a case where the receiving section 21b has received the polling request 5, the receiving section 21b sends the polling request 5 to the transmitting section 22b.

Moreover, the receiving section 21b receives self-propelled cleaner identification information 4b and polling start information 9c from the server 300. The receiving section 21b then sends the self-propelled cleaner identification information 4b and the polling start information 9c to the transmitting section 22b.

When the transmitting section 22b has received the self-propelled cleaner identification information 4b from the identification information collating section 13, the transmitting section 22b transmits the self-propelled cleaner identification information 4b to the smart phone 100. When the transmitting section 22b has received authentication information 6 from the identification information collating section 13, the transmitting section 22b transmits the authentication information 6 to the server 300.

When the transmitting section 22b has received the self-propelled cleaner identification information 4b or the polling start information 9c from the receiving section 21b, the transmitting section 22b transmits the self-propelled cleaner identification information 4b or the polling start information 9c to the smart phone 100. When the receiving section 21b has received the polling request 5, the transmitting section 22b transmits, to the server 300, a request 9b for a control command from the smart phone 100.

Upon receipt of a connection request 2 from the receiving section 21b, the identification information collating section (collating means) 13 judges whether or not self-propelled cleaner identification information 4b contained in the connection request 2 is identical to self-propelled cleaner identification information 4b of the self-propelled cleaner 200 which information 4b is stored in the storage section 30b. In a case where the pieces of self-propelled cleaner identification information 4b are identical to each other, the identification information collating section 13 sends authentication information 6 to the transmitting section 22b.

The authentication information 6 is information which indicates that an outdoor pairing between the smart phone 100 and the self-propelled cleaner 200 is authenticated. The authentication information 6 contains at least (i) self-propelled cleaner identification information 4b of the self-propelled cleaner 200 and (ii) communication information 4c contained in the connection request 2 given from the smart phone 100.

Upon receipt of the request 9a distributed by a broadcast from the receiving section 21b, the identification information collating section 13 reads out self-propelled cleaner identification information 4b from the storage section 30b and then sends the self-propelled cleaner identification information 4b to the transmitting section 22b.

The storage section 30b is a storage apparatus that can store self-propelled cleaner identification information 4b. A concrete hardware configuration of the storage section 30b can be identical with that of the storage section 30a.

[Configuration of Server 300]

The following description will discuss a configuration of the server 300 in detail, with reference to FIG. 3. FIG. 3 is a block diagram illustrating a configuration of main parts of the server 300. The following description will discuss functions of a communication section 20c (receiving section 21c, transmitting section 22c), a data storing section 14, and a storage section 30c, in this order.

The communication section 20c has a function identical to those of the communication section 20a and the communication section 20b, and therefore a detailed description of the communication section 20c is omitted. The communication section 20c includes a receiving section 21c and a transmitting section 22c.

The receiving section 21c receives smart phone identification information 4a from the smart phone 100 and then sends the smart phone identification information 4a to the data storing section 14. Moreover, the receiving section 21c receives a request 9b from the self-propelled cleaner 200 and then sends the request 9b to the data storing section 14.

Furthermore, the receiving section 21c receives authentication information 6 from the self-propelled cleaner 200. Then, the receiving section 21c sends (i) the authentication information 6 to the data storing section 14 and (ii) self-propelled cleaner identification information 4b, which is contained in the authentication information 6, to the transmitting section 22c.

Upon receipt of communication information 4c from the data storing section 14, the transmitting section 22c transmits the communication information 4c to the smart phone 100. Moreover, upon receipt of self-propelled cleaner identification information 4b from the receiving section 21c, the transmitting section 22c transmits the self-propelled cleaner identification information 4b to the self-propelled cleaner 200.

Furthermore, upon receipt of polling start information 9c from the data storing section 14, the transmitting section 22c transmits the polling start information 9c to the self-propelled cleaner 200. Here, the polling start information 9c is information which indicates that a polling start flag has been set by the data storing section 14.

The data storing section (storing means) 14 causes the storage section 30c to store outdoor pairing information 3b, in a case where the data storing section 14 has received, from the self-propelled cleaner 200, authentication information 6 which indicates that an outdoor pairing which allows the self-propelled cleaner 200 to be controlled by the smart phone 100 by using a communication via the wide area network 8b, has been authenticated by the self-propelled cleaner 200.

Specifically, the data storing section 14 judges whether or not communication information 4c, which has been transmitted from the transmitting section 22c to the smart phone 100, is identical to communication information 4c which is contained in authentication information 6 sent from the receiving section 21c. In a case where the pieces of communication information 4c are identical to each other, the data storing section 14 (i) associates smart phone identification information 4a stored in the storage section 30c with self-propelled cleaner identification information 4b contained in the authentication information 6 and (ii) causes the storage section 30c to store, as outdoor pairing information 3b, the smart phone identification information 4a and the self-propelled cleaner identification information 4b which have been thus associated with each other.

Upon receipt of smart phone identification information 4a from the receiving section 21c, the data storing section 14 (i) causes the storage section 30c to store the smart phone identification information 4a and (ii) sends communication information 4c to the transmitting section 22c.

Upon receipt of a request 9b from the receiving section 21c, the data storing section 14 sets a polling start flag that corresponds to outdoor pairing information 3b of the smart phone 100 and the self-propelled cleaner 200. Then, the data storing section 14 sends polling start information 9c to the transmitting section 22c.

The storage section 30c is a storage apparatus that can store outdoor pairing information 3b. A concrete hardware configuration of the storage section 30c can be identical with that of the storage section 30a.

[Processes Carried Out in Pairing System 400]

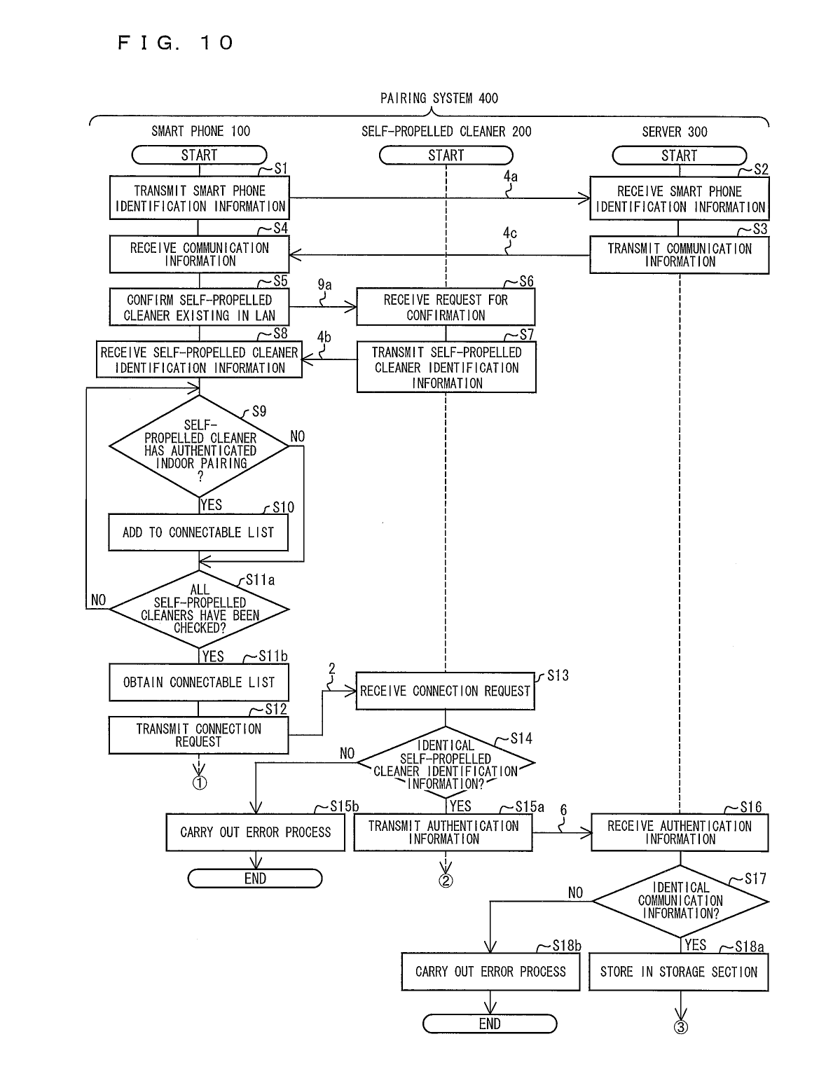

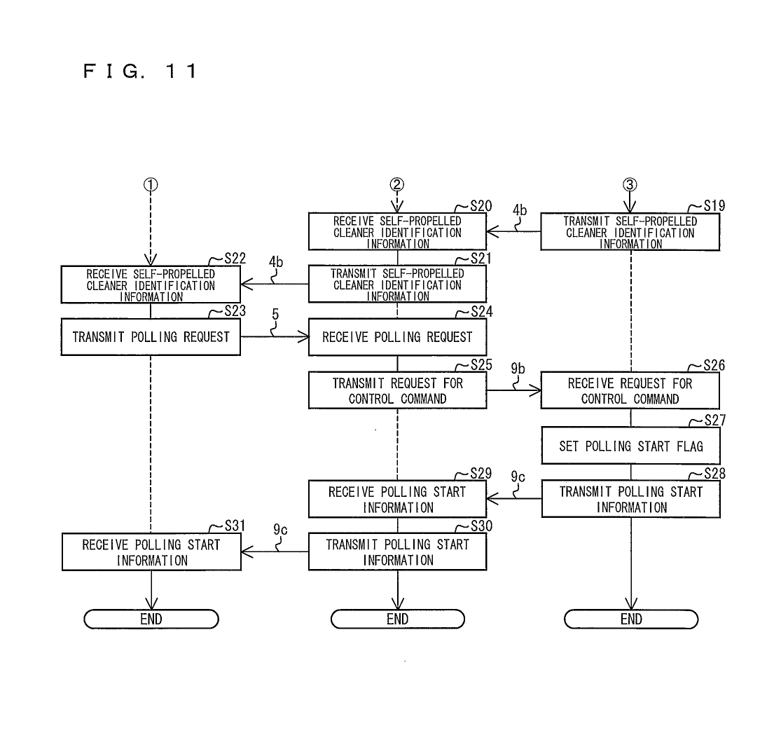

The following description will discuss a flow of processes carried out in the pairing system 400, with reference to FIGS. 10 and 11. FIG. 10 is a flowchart illustrating an example of a first half of processes carried out in the pairing system 400 (i.e., processes carried out by the smart phone 100, the self-propelled cleaner 200, and the server 300). FIG. 11 is a flowchart illustrating an example of a second half of the processes carried out in the pairing system 400.

Due to limitations of space in the drawings, the series of processes are depicted by being divided into (i) FIG. 10 illustrating the first half of the series of processes and (ii) FIG. 11 illustrating the second half of the series of processes. In the descriptions below, terms “ . . . step” in parentheses indicate steps in a controlling method.

Upon receipt of instruction information 7d, which indicates an instruction on carrying out an outdoor pairing, from the input control section 42, the transmitting section 22a transmits smart phone identification information 4a to the server 300 (step 1: hereinafter, abbreviated as “S1”).

When the receiving section 21c has received smart phone identification information 4a (S2), the data storing section 14 causes the storage section 30c to store the smart phone identification information 4a, and the transmitting section 22c transmits communication information 4c to the smart phone 100 (S3).

When the receiving section 21a has received communication information 4c (S4), the transmitting section 22a transmits, by a broadcast, a request 9a for self-propelled cleaner identification information 4b to all self-propelled cleaners 200 which exist in the identical LAN 8a (S5). This allows the smart phone 100 to confirm existence of all the self-propelled cleaners 200 which can be communicated via the LAN 8a.

After the receiving section 21a has received the communication information 4c (i.e., after S4 but before S5), the smart phone 100 can display, on the display surface 72, a screen that prompts the user to agree to rules for a mode (outdoor mode) in which the outdoor pairing is carried out. In a case where the user carries out an operation for indicating agreement (e.g., the user taps an “AGREE” button), the smart phone 100 can transmit, to the server 300, information which indicates that the user has agreed. It is possible to employ a configuration in which the transmitting section 22a carries out the process of S5 only in a case where a response (e.g., a template of a page for selecting an outdoor mode pairing) to the information indicative of agreement is received from the server 300.

When the receiving section 21b has received the request 9a distributed by the broadcast (S6), the identification information collating section 13 reads out self-propelled cleaner identification information 4b from the storage section 30b, and the transmitting section 22b transmits the self-propelled cleaner identification information 4b, which has been thus read out, to the smart phone 100 (S7). In this case, the transmitting section 22b can also transmit a nickname, which has been set to the self-propelled cleaner 200 in advance, together with the self-propelled cleaner identification information 4b.

When the receiving section 21a has received self-propelled cleaner identification information 4b (S8), the authentication judging section 12a judges whether or not a self-propelled cleaner 200, which is identified by the self-propelled cleaner identification information 4b, is a self-propelled cleaner which has authenticated an indoor pairing with the smart phone 100 (S9, first judging step). In a case where the self-propelled cleaner 200 is determined to have authenticated (YES in S9), the list obtaining section 11 adds the self-propelled cleaner 200 to the connectable device list 1 (S10).

The processes in S9 and S10 are carried out with respect to all self-propelled cleaners 200 (i.e., to all pieces of self-propelled cleaner identification information 4b) which have responded to the request 9a distributed by the broadcast (S11a), and thereby the list obtaining section 11 obtains a connectable device list 1 (S11b, obtaining step).

Upon receipt, from the input control section 42, of instruction information 7d which indicates that a self-propelled cleaner 200, which the user intends to pair with the smart phone 100 by an outdoor pairing, has been selected based on the connectable device list 1 displayed on the display surface 72, the transmitting section 22a transmits a connection request 2 which contains self-propelled cleaner identification information 4b and communication information 4c to the self-propelled cleaner 200 (S12, first transmitting step).

When the receiving section 21b has received the connection request 2 (S13), the identification information collating section 13 judges whether or not the self-propelled cleaner identification information 4b contained in the connection request 2 is identical to self-propelled cleaner identification information 4b stored in the storage section 30b (S14).

In a case where the pieces of self-propelled cleaner identification information 4b are identical to each other (YES in S14), the transmitting section 22b transmits, to the server 300, authentication information 6 which contains the self-propelled cleaner identification information 4b and the communication information 4c (S15a). In a case where the pieces of self-propelled cleaner identification information 4b are not identical to each other (NO in S14), the self-propelled cleaner 200 carries out a predetermined error process (S15b). For example, the transmitting section 22b transmits information, which indicates that an error has occurred, to the smart phone 100. In a case where the receiving section 21a has received the information, the smart phone 100 can display, to the user, a screen (e.g., an error screen D8 illustrated in FIG. 5) which indicates that the outdoor pairing failed.

When the receiving section 21c has received the authentication information 6 (S16), the data storing section 14 judges whether or not the communication information 4c, which has been transmitted to the smart phone 100 in S3, is identical to the communication information 4c contained in the authentication information 6 which has been received from the self-propelled cleaner 200 (S17).

In a case where the pieces of communication information 4c are determined to be identical to each other (YES in S17), the data storing section 14 (i) associates the smart phone identification information 4a which has been stored in the storage section 30c in S3 with the self-propelled cleaner identification information 4b contained in the authentication information 6 and (ii) causes the storage section 30c to store, as outdoor pairing information 3b, the smart phone identification information 4a and the self-propelled cleaner identification information 4b which have been thus associated with each other (S18a, storing step). In other words, the server 300 stores the outdoor pairing information 3b which indicates that the outdoor pairing has been established between the smart phone 100 and the self-propelled cleaner 200 (then continued on the second half of the processes illustrated in FIG. 11).

In a case where the pieces of communication information 4c are determined to be not identical to each other, the server 300 carries out a predetermined error process (S18b). For example, the transmitting section 22c transmits information, which indicates that an error has occurred, to the smart phone 100. In a case where the receiving section 21a has thus received the information, the smart phone 100 can display, to the user, a screen (e.g., an error screen D8 illustrated in FIG. 5) which indicates that the outdoor pairing failed.

In order to report the establishment of the outdoor pairing to the smart phone 100 and the self-propelled cleaner 200, the transmitting section 22c transmits the self-propelled cleaner identification information 4b contained in the authentication information 6 to the self-propelled cleaner 200 (S19).

When the receiving section 21b has received the self-propelled cleaner identification information 4b (S20), the transmitting section 22b transmits the self-propelled cleaner identification information 4b to the smart phone 100 (S21). Then, the receiving section 21a receives the self-propelled cleaner identification information 4b (S22). By carrying out the processes of S19 through S22, the smart phone 100 and the self-propelled cleaner 200 can recognize that (i) the server 300 has caused the storage section 30c to store the outdoor pairing information 3b and accordingly (ii) the outdoor pairing has been successfully established.

For example, after the process of S20, the self-propelled cleaner 200 can synchronize time by utilizing header information of the communication with the server 300. This allows the self-propelled cleaner 200 and the server 300 to be accurately synchronized with each other.

When the receiving section 21a has received the self-propelled cleaner identification information 4b (S22), the transmitting section 22a transmits, to the self-propelled cleaner 200 which has been successfully paired with the smart phone 100 by the outdoor pairing, a polling request 5 containing the self-propelled cleaner identification information 4b of the self-propelled cleaner 200 (S23).

When the receiving section 21b has received the polling request 5 (S24), the transmitting section 22b transmits, to the server 300, a request 9b for a control command given from the smart phone 100 (S25).

When the receiving section 21c has received the request 9b (S26), the data storing section 14 sets a polling start flag that corresponds to the outdoor pairing information 3b of the smart phone 100 and the self-propelled cleaner 200 (S27). Then, the transmitting section 22c transmits, to the self-propelled cleaner 200, polling start information 9c which indicates that the polling start flag has been set (S28).

When the receiving section 21b has received the polling start information 9c (S29), the transmitting section 22b transmits the polling start information 9c to the smart phone 100 (S30), and then the receiving section 21a receives the polling start information 9c (S31). This allows the smart phone 100 to confirm that the smart phone 100 has been properly paired with the self-propelled cleaner 200 by the outdoor pairing.

[Effects Brought about by Smart Phone 100, Self-Propelled Cleaner 200, and Server 300]

The smart phone 100 and the self-propelled cleaner 200 bring about effects of (i) reducing an operation load on the user caused due to a plurality of pairings and therefore (ii) improving usability.

The server 300 (i) can specify a self-propelled cleaner 200 which can be controlled by using a communication via the WAN 8b and therefore (ii) brings about an effect of enabling the smart phone 100 to control the self-propelled cleaner 200.

### Embodiment 2

The following description will discuss Embodiment 2 of the present invention in detail, with reference to FIGS. 12 through 14. Note that, in the present embodiment, only (i) configurations added to Embodiment 1 and (ii) configurations different from those of Embodiment 1 will be described. In other words, the configurations and the like described in Embodiment 1 can be all included in Embodiment 2. Moreover, the definitions of the terms used in Embodiment 2 are identical with those used in Embodiment 1.

[Difference from Embodiment 1]

A pairing system 401 of the present embodiment includes a smart phone 101 (see FIG. 12), a self-propelled cleaner 201 (see FIG. 13), and a server 300 (see FIG. 3). Note that, as indicated by the identical reference numeral, the server 300 of the present embodiment can be identical with the server 300 of Embodiment 1.

The present embodiment is different from Embodiment 1 in that the self-propelled cleaner 201 carries out a process of judging whether or not the smart phone 101 is paired with the self-propelled cleaner 201 by an indoor pairing.

According to Embodiment 1, the smart phone 100 includes the authentication judging section 12a (see FIG. 1). The authentication judging section 12a judges, with reference to indoor pairing information 3a stored in the storage section 30a, whether or not an indoor pairing has been established between the smart phone 100 and the self-propelled cleaner 200 (see S9 of FIG. 10). This allows the smart phone 100 to judge whether or not a self-propelled cleaner 200, which has responded to a request 9a, is a self-propelled cleaner which can be paired with the smart phone 100 by an outdoor pairing.

On the other hand, the smart phone 101 of the present embodiment does not include the authentication judging section 12a. Instead, the self-propelled cleaner 201 includes an authentication judging section 12b. In this case, upon receipt of a request 9a from the smart phone 101, the authentication judging section 12b of the self-propelled cleaner 201 judges, with reference to indoor pairing information 3a stored in the storage section 30b, whether or not an indoor pairing has been established between the smart phone 101 and the self-propelled cleaner 201. Then, only in a case where the indoor pairing is determined to have been established, a response to the request 9a is given to the smart phone 101.

With the configuration, the self-propelled cleaner 201 can cause the smart phone 101 to obtain, as information of a candidate self-propelled cleaner 201 that can be paired with the smart phone 101 by an outdoor pairing, information on the self-propelled cleaner 201 which has already been paired with the smart phone 101 by an indoor pairing.

[Configuration of Smart Phone 101]

The following description will discuss a configuration of the smart phone 101 with reference to FIG. 12. FIG. 12 is a block diagram illustrating a configuration of main parts of the smart phone 101. Note that the same reference numerals are given to members identical to those included in the smart phone 100, and descriptions of such members are omitted.

A list obtaining section (obtaining means) 11 adds all pieces of self-propelled cleaner identification information 4b sent from the receiving section 21a to a list, and thus obtains the list as a connectable device list 1. The list obtaining section 11 sends the connectable device list 1, which has been thus obtained, to a display control section 71.

[Configuration of Self-Propelled Cleaner 201]

The following description will discuss a configuration of the self-propelled cleaner 201 with reference to FIG. 13. FIG. 13 is a block diagram illustrating a configuration of main parts of the self-propelled cleaner 201. The self-propelled cleaner 201 includes the authentication judging section 12b in addition to the constituent members included in the self-propelled cleaner 200 of Embodiment 1.

The following description will discuss functions of the authentication judging section 12b, an identification information collating section 13, and a transmitting section 22b in this order. The other members are identical with those of Embodiment 1, and descriptions of such members are omitted.

When a response is requested from the smart phone 101 which can communicate with the self-propelled cleaner 201 via the local area network 8a, the authentication judging section (second judging means) 12b judges whether or not the smart phone 101 establishes a communication connection which (i) allows the self-propelled cleaner 201 to be controlled by using a communication via the local area network 8a and (ii) has been authenticated as an indoor pairing.

Specifically, upon receipt of the request 9a from the receiving section 21b, the authentication judging section 12b judges, with reference to the indoor pairing information 3a stored in the storage section 30b, whether or not an indoor pairing has been established between the smart phone 101 and the self-propelled cleaner 201. In a case where the indoor pairing has been established, the authentication judging section 12b sends judgment information 9d, which indicates that the indoor pairing has been established, to the identification information collating section 13.

Upon receipt of the judgment information 9d, which indicates that the indoor pairing has been established, from the authentication judging section 12b, the identification information collating section (collating means) 13 reads out self-propelled cleaner identification information 4b from the storage section 30b and then sends the self-propelled cleaner identification information 4b to the transmitting section 22b.

Moreover, upon receipt of a connection request 2 from the receiving section 21b, the identification information collating section 13 judges whether or not self-propelled cleaner identification information 4b contained in the connection request 2 is identical to self-propelled cleaner identification information 4b of the self-propelled cleaner 200 which information 4b is stored in the storage section 30b. In a case where the pieces of self-propelled cleaner identification information 4b are identical to each other, the identification information collating section 13 sends authentication information 6 to the transmitting section 22b.

In a case where the smart phone 101 is determined, by the authentication judging section 12b, to establish the indoor pairing which has been authenticated, the transmitting section (second transmitting means) 22b transmits, to the smart phone 101, self-propelled cleaner identification information 4b based on which the self-propelled cleaner 201 can be identified. Specifically, upon receipt of the self-propelled cleaner identification information 4b from the identification information collating section 13, the transmitting section 22b transmits the self-propelled cleaner identification information 4b to the smart phone 101.

In a case where the transmitting section (third transmitting means) 22b has received, as a response from the smart phone 101 to the self-propelled cleaner identification information 4b which has been transmitted from the transmitting section 22b, a connection request 2 for an outdoor pairing which allows the self-propelled cleaner 201 to be controlled by using a communication via the wide area network 8b, the transmitting section 22b transmits authentication information 6, which indicates that the outdoor pairing has been authenticated, to the server 300. Specifically, upon receipt of the authentication information 6 from the identification information collating section 13, the transmitting section 22b transmits the authentication information 6 to the server 300.

[Processes Carried Out in Pairing System 401]

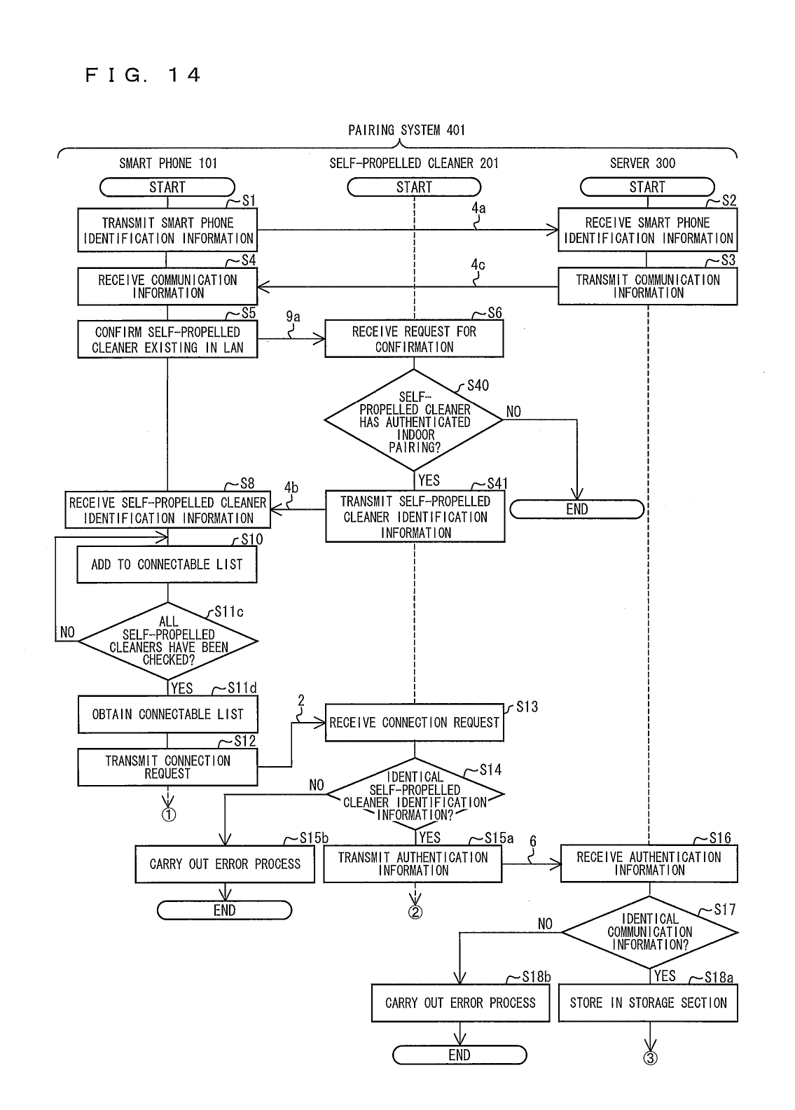

The following description will discuss a flow of processes carried out in a pairing system 401, with reference to FIG. 14. FIG. 14 is a flowchart illustrating an example of a first half of processes carried out in the pairing system 401 (i.e., processes carried out by the smart phone 101, the self-propelled cleaner 201, and the server 300).

Due to limitations of space in the drawings, the series of processes are depicted by being divided into (i) FIG. 14 illustrating the first half of the series of processes and (ii) FIG. 11 illustrating the second half of the series of processes. In the descriptions below, some processes, which are identical with those described with reference to FIG. 10, are given the same reference numerals and are not described hare (that is, processes of S1 through S5, S15b through S18a are not described below).

When the receiving section 21b has received a request 9a distributed by a broadcast (S6), the authentication judging section 12b judges whether or not the self-propelled cleaner 201 has authenticated an indoor pairing with the smart phone 101 (S40, second judging step).

In a case where the self-propelled cleaner 201 is determined to have authenticated the indoor pairing (YES in S40), the identification information collating section 13 reads out self-propelled cleaner identification information 4b from the storage section 30b, and the transmitting section 22b then transmits the self-propelled cleaner identification information 4b, which has been thus read out, to the smart phone 101 (S41, second transmitting step). On the other hand, in a case where the self-propelled cleaner 201 is determined to have not authenticated the indoor pairing (NO in S40), the self-propelled cleaner 201 ends the process without responding to the request 9a.

When the receiving section 21a has received the self-propelled cleaner identification information 4b (S8), the list obtaining section 11 adds the self-propelled cleaner 201 to the connectable device list 1 (S10). The process in S10 is carried out with respect to all self-propelled cleaners 201 (i.e., to all pieces of self-propelled cleaner identification information 4b) which have transmitted the pieces of self-propelled cleaner identification information 4b (S11c), and thereby the list obtaining section 11 obtains the connectable device list 1 (S11d, obtaining step).

Upon receipt, from the input control section 42, of instruction information 7d which indicates that a self-propelled cleaner 201, which the user intends to pair with the smart phone 101 by an outdoor pairing, has been selected based on the connectable device list 1 displayed on the display surface 72, the transmitting section 22a transmits a connection request 2 which contains self-propelled cleaner identification information 4b and communication information 4c to the self-propelled cleaner 201 (S12, first transmitting step).

When the receiving section 21b has received the connection request 2 (S13), the identification information collating section 13 judges whether or not the self-propelled cleaner identification information 4b contained in the connection request 2 is identical to self-propelled cleaner identification information 4b stored in the storage section 30b (S14).

In a case where the pieces of self-propelled cleaner identification information 4b are identical to each other (YES in S14), the transmitting section 22b transmits, to the server 300, authentication information 6 which contains the self-propelled cleaner identification information 4b and the communication information 4c (S15a, third transmitting step).

[Effects Brought about by Smart Phone 101 and Self-Propelled Cleaner 201]

The smart phone 101 and the self-propelled cleaner 201 bring about effects of (i) reducing an operation load on the user caused due to a plurality of pairings and therefore (ii) improving usability.

[Combination of Configurations (Technical Means) in Embodiments]

Note that the configurations in the embodiments can be combined as appropriate. That is, all the configurations described in the embodiments can be employed not only in the above described embodiments but also in other embodiments by combining all of or some of the configurations, and an embodiment derived from such combination is also encompassed in the technical scope of the present invention.

[Configuration Examples Achieved by Software]

Lastly, each block of the smart phone 100, the smart phone 101, the self-propelled cleaner 200, the self-propelled cleaner 201, or the server 300 can be configured by hardware with the use of a logic circuit formed on an integrated circuit (IC chip) or by software with the use of CPU (Central Processing Unit).

In the case where each block is configured by software, the smart phone 100, the smart phone 101, the self-propelled cleaner 200, the self-propelled cleaner 201, or the server 300 includes a CPU, a ROM (Read Only Memory), a RAM (Random Access Memory), and a storage device (storage medium) such as a memory. The CPU executes instructions of programs for realizing the functions. In the ROM, the programs are stored. Into the RAM, the programs are loaded. In the storage device, the programs and various data are stored. The objective of the present invention can also be achieved, by (i) supplying a storage medium, in which program codes (executable programs, intermediate code programs, source programs) of programs for controlling the smart phone 100, the smart phone 101, the self-propelled cleaner 200, the self-propelled cleaner 201, or the server 300, each being configured by software for realizing the functions, are stored so that a computer can read them, to the smart phone 100, the smart phone 101, the self-propelled cleaner 200, the self-propelled cleaner 201, or the server 300, and then (ii) causing the computer (or CPU or MPU) to read and execute the program codes stored in the storage medium.

The storage medium can be, for example, a tape, such as a magnetic tape or a cassette tape; a disk including (i) a magnetic disk such as a floppy (Registered Trademark) disk or a hard disk and (ii) an optical disk such as CD-ROM, MO, MD, DVD, or CD-R; a card such as an IC card (memory card) or an optical card; a semiconductor memory such as a mask ROM, EPROM, EEPROM (Registered Trademark), or flash ROM; or a logic circuit such as PLD (Programmable Logic Device) or FPGA (Field Programmable Gate Array).

Alternatively, the smart phone 100, the smart phone 101, the self-propelled cleaner 200, the self-propelled cleaner 201, or the server 300 can be arranged to be connectable to a communications network so that the program codes can be supplied thereto via the communications network. The communications network is not limited to a specific one, provided that the program codes can be transferred via the communications network. The communications network can be, for example, the Internet, an intranet, extranet, LAN, ISDN, VAN, CATV communications network, virtual private network, telephone line network, mobile communications network, or satellite communications network. The transfer medium which constitutes the communications network is not limited to a specific configuration or a specific type, provided that the program codes can be transferred via the transfer medium. The transfer medium can be, for example, wired line such as IEEE 1394, USB, electric power line, cable TV line, telephone line, or ADSL (Asymmetric Digital Subscriber Line) line; or wireless such as infrared radiation (IrDA, remote control), Bluetooth (Registered Trademark), IEEE 802.11 wireless, HDR (High Data Rate), NFC (Near Field Communication), DLNA (Digital Living Network Alliance), mobile telephone network, satellite line, or terrestrial digital network. Note that, the present invention can be realized by a computer data signal (i) which is realized by electronic transmission of the program code and (ii) which is embedded in a carrier wave.

As above described in this specification, the term “means” does not necessarily indicate a physical means. Therefore, functions of the means may be realized by software. Further, a function of one of the means may be realized by two or more physical means. Alternatively, functions of two or more of the means may be realized by one (1) physical means.

### Main Points

According to the information-processing device of an aspect 1 of the present invention,

(1) the information-processing device (smart phone 100, 101) communicates with a control target device (self-propelled cleaner 200, 201) via a network so as to control the control target device,
(2) the information-processing device includes obtaining means (list obtaining section 11) for obtaining specification information (connectable device list 1) for specifying a control target device which (i) have authenticated, as a first communication connection (indoor pairing), a communication connection which allows the control target device to be controlled by using a communication via a first network (local area network 8a) and therefore (ii) is ready to authenticate, as a second communication connection (outdoor pairing), a communication connection which allows the control target device to be controlled via a second network (wide area network 8b) that is different from the first network, and
(3) the information-processing device includes first transmitting means (transmitting section 22a) for transmitting a connection request (connection request 2) to a control target device, which has been selected by a user based on information obtained by the obtaining means, so as to establish the second communication connection with the control target device.

According to the method of the aspect 1 of the present invention for controlling an information-processing device,

(1) the method is a method for controlling an information-processing device which communicates with a control target device via a network so as to control the control target device,
(2) the method includes the step (S11b, S11d) of obtaining specification information for specifying a control target device which (i) has authenticated, as a first communication connection, a communication connection which allows the control target device to be controlled by using a communication via a first network and therefore (ii) is ready to authenticate, as a second communication connection, a communication connection which allows the control target device to be controlled by using a communication via a second network that is different from the first network, and
(3) the method includes the step (S12) of transmitting a connection request to a control target device, which has been selected by a user based on specification information obtained in the obtaining step, so as to establish the second communication connection with the control target device.

According to the configurations (1) through (3), the information-processing device and the method for controlling the device in accordance with the aspect 1 of the present invention can obtain specification information for specifying a control target device which (i) has authenticated the first communication connection and therefore (ii) can authenticate the second communication connection. That is, the information-processing device and the method can obtain, as information of a candidate control target device that can establish the second communication connection, information on the control target device which has already been paired with the information-processing device by the first communication connection.

According to the information-processing device and the method, the connection request is transmitted to the control target device, which has been selected by the user from the information, so as to establish the second communication connection with the control target device. That is, according to the information-processing device and the method, the user merely needs to select a control target device which is intended to establish the second communication connection with the information-processing device, and the user does not need to repeatedly carry out the operation identical with that required for establishing the first communication connection.

According to the information-processing device and the method for controlling the device in accordance with the aspect 1 of the present invention, it is possible to (i) reduce an operation load on the user caused in establishing a plurality of communication connections and therefore (ii) improve usability.

According to the information-processing device in accordance with an aspect 2 of the present invention, in addition to the aspect 1, it is possible that:

(1) the information-processing device includes first judging means (authentication judging section 12a) for judging whether or not the control target device, which communicates with the information-processing device via the first network, has authenticated the first communication connection, and
(2) the obtaining means obtains the specification information for specifying the control target device which has been determined, by the first judging means, to have authenticated the first communication connection.

According to the method in accordance with the aspect 2 of the present invention for controlling the information-processing device, in addition to the aspect 1, it is possible that:

(1) the method includes the step (S9) of judging whether or not the control target device, which communicates via the first network, has authenticated the first communication connection, and,
(2) in the obtaining step, specification information for specifying a control target device, which has been determined in the judging step to have authenticated the first communication connection, is obtained.

According to the configurations (1) and (2), the information-processing device and the method for controlling the device in accordance with the aspect 2 of the present invention judge whether or not the control target device, which can communicate with the information-processing device via the first network, has authenticated the first communication connection. That is, the information-processing device and the method judge whether or not the first communication connection has already been established between the control target device and the information-processing device.

Then, the information-processing device and the method obtain specification information for specifying the control target device which has been determined to have established the first communication connection. That is, the information-processing device and the method can obtain, as information of a candidate control target device that can establish the second communication connection, information on the control target device which has already been paired with the information-processing device by the first communication connection.

With the configuration, as with the aspect 1, the user merely needs to select a control target device which is intended to establish the second communication connection with the information-processing device, and the user does not need to repeatedly carry out the operation identical with that required for establishing the first communication connection.

According to the information-processing device and the method for controlling the device in accordance with the aspect 2 of the present invention, it is possible to (i) reduce an operation load on the user caused in establishing a plurality of communication connections and therefore (ii) improve usability.

According to the information-processing device of an aspect 3 of the present invention, in addition to the aspect 1 or 2, it is possible that:

(1) the information-processing device includes first receiving means (receiving section 21a) for receiving communication information (communication information 4c) from a server, the communication information being used to identify communication, and
(2) the first transmitting means transmits a connection request to the control target device by using the communication which is identified based on the communication information received by the first receiving means.

According to the configurations (1) and (2), the information-processing device in accordance with the aspect 3 of the present invention (i) receives, from the server, the communication information for identifying a communication and (ii) transmits a connection request to the control target device with the communication identified based on the identification information.

With the configuration, the information-processing device of the aspect 3 of the present invention can cause the server to carry out collation for judging whether or not the information-processing device which has transmitted the connection request is identical to the information-processing device which has obtained the communication information from the server. In a case where the information-processing devices are determined to be different from each other by the collation, the second communication connection with the information-processing device is not permitted.

This allows the information-processing device (i) to prevent leakage of information due to another information-processing device cutting into the communication and (ii) to provide a stronger communication security.

According to the information-processing device of an aspect 4 of the present invention which includes any one of the aspects 1 through 3,

(1) in a case where the second communication connection has been authenticated by a control target device which has been selected by the user based on the specification information, the first transmitting means can transmit, to the control target device, confirmation information (polling request 5) for confirming that the control target device has become ready to be controlled by using the second communication connection.

According to the configuration (1), in a case where the second communication connection is authenticated by a control target device which has been intended by the user to establish the second communication connection with the information-processing device, the information-processing device of the aspect 4 of the present invention transmits, to the control target device, confirmation information for confirming that the control target device has become ready to be controlled with the second communication connection.

With the configuration, the information-processing device can confirm that the control target device can be surely controlled, and it is therefore possible to enhance stability of functions achieved by the information-processing device.

In order to attain the object, according to the control target device of an aspect 5 of the present invention,

(1) the control target device is a control target device (self-propelled cleaner 200, 201) which communicates with an information-processing device via a network so as to be controlled by the information-processing device,
(2) the control target device includes second judging means (authentication judging section 12b) for judging, when a response is requested from the information-processing device which communicates with the control target device via a first network, whether or not the information-processing device establishes a communication connection which (i) allows the control target device to be controlled by using a communication via the first network and (ii) has been authenticated as a first communication connection,
(3) the control target device includes second transmitting means (transmitting section 22b) for transmitting device information for identifying the control target device to the information-processing device in a case where the second judging means has determined that the information-processing device establishes the communication connection which has been authenticated, and
(4) the control target device includes third transmitting means (transmitting section 22b) for transmitting, to a server, authentication information which indicates that a second communication connection has been authenticated, the third transmitting means transmitting the authentication information in a case where a connection request for the second communication connection, which allows the control target device to be controlled by using a communication via a second network that is different from the first network, is received from the information-processing device as a response to the device information which has been transmitted from the second transmitting means.

In order to attain the object, according to the method of the aspect 5 of the present invention for controlling the control target device,

(1) the method is a method for controlling a control target device which communicates with an information-processing device via a network so as to be controlled by the information-processing device,
(2) the method includes the step (S40) of judging, when a response is requested from the information-processing device which communicates with the control target device via a first network, whether or not the information-processing device establishes a communication connection which (i) allows the control target device to be controlled by using a communication via the first network and (ii) has been authenticated as a first communication connection,
(3) the method includes the step (S41) of transmitting device information (self-propelled cleaner identification information 4b) for identifying the control target device to the information-processing device in a case where the information-processing device has been determined in the judging step to establish the communication connection which has been authenticated, and
(4) the method includes the step (S15a) of transmitting, to a server (server 300), authentication information (authentication information 6) which indicates that a second communication connection has been authenticated, the authentication information being transmitted in a case where a connection request for the second communication connection, which allows the control target device to be controlled by using a communication via a second network that is different from the first network, is received from the information-processing device as a response to the device information which has been transmitted in the step of transmitting device information.

According to the configurations (1) through (4), when a response is requested from the information-processing device which can communicate with the control target device via the first network, the control target device and the method for controlling the device in accordance with the aspect 5 of the present invention can judge whether or not the information-processing device establishes the authenticated first communication connection. That is, the control target device and the method judge whether or not the first communication connection has already been established between the information-processing device and the control target device.

The control target device and the method transmit, to the information-processing device which has been determined to have established the first communication connection, the device information for identifying the control target device. With the configuration, the control target device and the method can cause the information-processing device to obtain, as information of a candidate control target device that can establish a second communication connection, information on the control target device which has already been established the first communication connection with the information-processing device.

In a case where the connection request for a second communication connection is received from the information-processing device as a response to the device information, the control target device and the method transmit authentication information, which indicates that the second communication connection has been authenticated, to the server.

With the configuration, as with the above aspects, the user merely needs to select a control target device which is intended to establish the second communication connection, and the user does not need to repeatedly carry out the operation identical with that required for establishing the first communication connection.

According to the control target device and the method for controlling the device in accordance with the aspect 5 of the present invention, it is possible to (i) reduce an operation load on the user caused in establishing a plurality of communication connections and therefore (ii) improve usability.

According to an aspect 6 of the present invention, in addition to the aspect 5,

(1) the control target device includes collating means (identification information collating section 13) for judging, in a case where device information and the connection request for the second communication connection are received from the information-processing device, whether or not the device information is identical to device information which has been transmitted by the second transmitting means, and
(2) the third transmitting means can transmit the authentication information to the server in a case where the pieces of device information have been determined to be identical to each other by the collating means.

According to the configurations (1) and (2), the control target device in accordance with the aspect 6 of the present invention (i) carries out collation for judging whether or not the device information transmitted from the information-processing device is identical to the device information on the control target device, and (ii) transmits the authentication information to the server only when the pieces of device information are identical to each other. In a case where the pieces of device information are determined to be not identical to each other, the second communication connection with the information-processing device is not permitted.

This allows the control target device (i) to prevent leakage of information due to another information-processing device cutting into the communication and (ii) to provide a stronger communication security.

In order to attain the object, the server (server 300) of an aspect 7 of the present invention includes:

(1) storing means (data storing section 14) for causing a storage section (storage section 30c) to store connection information (outdoor pairing information 3b), which indicates that a second communication connection has been established between an information-processing device and a control target device, in a case where the server has received, from the control target device, authentication information which indicates that the second communication connection, which allows the control target device to be controlled by the information-processing device by using a communication via a second network, has been authenticated by the control target device.

In order to attain the object, the method for controlling the server of the aspect 7 of the present invention includes:

(1) the step (S18a) of causing a storage section to store connection information, which indicates that a second communication connection has been established between an information-processing device and a control target device, in a case where authentication information has been received from the control target device, the authentication information indicating that the second communication connection, which allows the control target device to be controlled by the information-processing device by using a communication via a second network, has been authenticated by the control target device.

According to the configuration (1), in a case where the authentication information is received from the control target device, the server and the method for controlling the server in accordance with the aspect 7 of the present invention cause the storage section to store the connection information which indicates that the second communication connection has been established between the information-processing device and the control target device.

Therefore, according to the server and the method for controlling the server, it is possible to specify a control target device that can be controlled via the second network, and this allows the information-processing device to control the control target device.

The pairing system (pairing system 400, 401) of an aspect 8 of the present invention includes:

(1) the information-processing device of any one of the aspects 1 through 4;
(2) the control target device of the aspect 5 or 6; and
(3) the server of the aspect 7.

According to the configurations (1) through (3), the pairing system brings about effects similar to those of the information-processing device or the control target device.

The information-processing device or the control target device can be realized by a computer. In such a case, the present invention encompasses (i) a control program which causes the computer to serve as each of the means of the information-processing device or the control target device and (ii) a computer-readable storage medium in which the control program is stored.

### INDUSTRIAL APPLICABILITY

The information-processing device of the present invention is applicable to various electronic apparatuses such as a smart phone, a mobile phone, a portable information terminal, a personal computer, and a tablet terminal.

The control target device of the present invention is applicable to an electronic apparatus (e.g., a self-propelled cleaner) which can be controlled by the information-processing device based on a control command received from the information-processing device.

The server of the present invention is applicable to various electronic apparatuses such as a personal computer and a general-purpose electronic computer.

### REFERENCE SIGNS LIST

1: Connectable device list (specification information)
2: Connection request (connection request)
3a: Indoor pairing information
3b: Outdoor pairing information (connection information)
4a: Smart phone identification information
4b: Self-propelled cleaner identification information (device information)
4c: Communication information (communication information)
5: Polling request (confirmation information)
6: Authentication information (authentication information)
8a: Local area network (first network)
8b: Wide area network (second network)
11: List obtaining section (obtaining means)
12a: Authentication judging section (first judging means)
12b: Authentication judging section (second judging means)
13: Identification information collating section (collating means)
14: Data storing section (storing means)
21a: Receiving section (first receiving means)
21b: Receiving section
21c: Receiving section
22a: Transmitting section (first transmitting means)
22b: Transmitting section (second transmitting means, third transmitting means)
22c: Transmitting section
30a: Storage section
30b: Storage section
30c: Storage section (storage section)
100: Smart phone (information-processing device)
101: Smart phone (information-processing device)
200: Self-propelled cleaner (control target device)
201: Self-propelled cleaner (control target device)
300: Server (server)
400: Pairing system (pairing system)
401: Pairing system (pairing system)

1. An information-processing device which communicates with a control target device via a network so as to control the control target device, said information-processing device comprising:
obtaining means for obtaining specification information for specifying a control target device which (i) have authenticated, as a first communication connection, a communication connection which allows the control target device to be controlled by using a communication via a first network and therefore (ii) is ready to authenticate, as a second communication connection, a communication connection which allows the control target device to be controlled by using a communication via a second network that is different from the first network; and
first transmitting means for transmitting a connection request to a control target device, which has been selected by a user based on specification information obtained by the obtaining means, so as to establish the second communication connection with the control target device.

2. An information-processing device as set forth in claim 1, further comprising:
first judging means for judging whether or not the control target device, which communicates with said information-processing device via the first network, has authenticated the first communication connection,
the obtaining means obtaining the specification information for specifying the control target device which has been determined, by the first judging means, to have authenticated the first communication connection.

3. An information-processing device as set forth in claim 1, further comprising:
first receiving means for receiving communication information from a server, the communication information being used to identify a communication,
the first transmitting means transmitting a connection request to the control target device by using the communication which is identified based on the communication information received by the first receiving means.

4. The information-processing device as set forth in claim 1, wherein:
in a case where the second communication connection has been authenticated by a control target device which has been selected by the user based on the specification information, the first transmitting means transmits, to the control target device, confirmation information for confirming that the control target device has become ready to be controlled by using the second communication connection.

5. A control target device which communicates with an information-processing device via a network so as to be controlled by the information-processing device, said control target device comprising:
second judging means for judging, when a response is requested from the information-processing device which communicates with said control target device via a first network, whether or not the information-processing device establishes a communication connection which (i) allows said control target device to be controlled by using a communication via the first network and (ii) has been authenticated as a first communication connection;
second transmitting means for transmitting device information for identifying said control target device to the information-processing device in a case where the second judging means has determined that the information-processing device establishes the communication connection which has been authenticated; and
third transmitting means for transmitting, to a server, authentication information which indicates that a second communication connection has been authenticated, the third transmitting means transmitting the authentication information in a case where a connection request for the second communication connection, which allows said control target device to be controlled by using a communication via a second network that is different from the first network, is received from the information-processing device as a response to the device information which has been transmitted from the second transmitting means.

6. A control target device as set forth in claim 5, further comprising:
collating means for judging, in a case where device information and the connection request for the second communication connection are received from the information-processing device, whether or not the device information is identical to device information which has been transmitted by the second transmitting means,
the third transmitting means transmitting the authentication information to the server in a case where the pieces of device information have been determined to be identical to each other by the collating means.

7. A server comprising:
storing means for causing a storage section to store connection information, which indicates that a second communication connection has been established between an information-processing device and a control target device, in a case where said server has received, from the control target device, authentication information which indicates that the second communication connection, which allows the control target device to be controlled by the information-processing device by using a communication via a second network, has been authenticated by the control target device.

8. A pairing system comprising an information-processing device recited in claim 1.

9. A method for controlling an information-processing device which communicates with a control target device via a network so as to control the control target device, said method comprising the steps of:
obtaining specification information for specifying a control target device which (i) has authenticated, as a first communication connection, a communication connection which allows the control target device to be controlled by using a communication via a first network and therefore (ii) is ready to authenticate, as a second communication connection, a communication connection which allows the control target device to be controlled by using a communication via a second network that is different from the first network; and
transmitting a connection request to a control target device, which has been selected by a user based on specification information obtained in the obtaining step, so as to establish the second communication connection with the control target device.

10. A method as set forth in claim 9, further comprising the step of:
judging whether or not the control target device, which communicates via the first network, has authenticated the first communication connection,
in the obtaining step, specification information for specifying a control target device, which has been determined in the judging step to have authenticated the first communication connection, being obtained.

11. A method for controlling a control target device which communicates with an information-processing device via a network so as to be controlled by the information-processing device, said method comprising the steps of:
judging, when a response is requested from the information-processing device which communicates with the control target device via a first network, whether or not the information-processing device establishes a communication connection which (i) allows the control target device to be controlled by using a communication via the first network and (ii) has been authenticated as a first communication connection;
transmitting device information for identifying the control target device to the information-processing device in a case where the information-processing device has been determined in the judging step to establish the communication connection which has been authenticated; and
transmitting, to a server, authentication information which indicates that a second communication connection has been authenticated, the authentication information being transmitted in a case where a connection request for the second communication connection, which allows the control target device to be controlled by using a communication via a second network that is different from the first network, is received from the information-processing device as a response to the device information which has been transmitted in the step of transmitting device information.

12. A method for controlling a server, said method comprising the step of:
causing a storage section to store connection information, which indicates that a second communication connection has been established between an information-processing device and a control target device, in a case where authentication information has been received from the control target device, the authentication information indicating that the second communication connection, which allows the control target device to be controlled by the information-processing device by using a communication via a second network, has been authenticated by the control target device.

13. A control program for operating an information-processing device recited in claim 1, the control program causing a computer to serve as the means of the information-processing device.

14. A control program for operating a control target device recited in claim 5, the control program causing a computer to serve as the means of the control target device.

15. A computer-readable storage medium in which a control program recited in claim 13 is stored.

16. A computer-readable storage medium in which a control program recited in claim 14 is stored.

17. A pairing system comprising a control target device recited in claim 5.

18. A pairing system comprising a server recited in claim 7.
